(19) United States
(12) Patent Application Publication
(10) Pub. No.: US 2001/0037945 A1
(43) Pub. Date: Nov. 8, 2001

(54) Liquid treatment equipment and liquid treatment method

(76) Inventors: Wataru Okase, Tsukui-gun (JP); Takenobu Matsuo, Tsukui-gun (JP); Koichiro Kimura, Tsukui-gun (JP); Kyungho Park, Kawasaki-shi (JP); Yoshinori Kato, Kuwana-shi (JP); Yasushi Yagi, Tsukui-gun (JP)

Correspondence Address: PILLSBURY WINTHROP LLP, 1600 TYSONS BOULEVARD, MCLEAN, VA, 22102, US

(21) Appl. No.: 09/849,275

(22) Filed: May 7, 2001

(30) Foreign Application Priority Data
May 8, 2000 (JP) P2000-174445
May 8, 2000 (JP) P2000-174441

(51) Int. Cl. C25D 3/00; C25D 17/00; B05C 11/00

(52) U.S. Cl. 205/261; 204/242; 204/227; 118/506

(57) ABSTRACT

Between a wafer and a holder holding a wafer, a seal member is disposed so that a contact surface is formed in an approximate plane, and an inner periphery surface is formed in an approximate plane and approximately vertical to a contact surface. The seal member, in a sealed state, has a brim portion of a radius of curvature of 0.5 mm or less at a boundary portion between an inner periphery surface of a seal member and a contact surface. Due to a brim portion, a gap between a contact surface of a seal member and a surface being plated of a wafer W can be made smaller, resulting in reducing bubbles entering in a gap.

### BACKGROUND OF THE INVENTION

1. Field of the Invention

The present invention relates to liquid treatment equipment for implementing liquid treatment to a substrate, in particular to liquid treatment equipment for implementing liquid treatment while sending an electric current to a substrate in contact with a treatment solution and a liquid treatment method therefor.

2. Description of the Related Art

So far, as equipment for implementing the plating to a silicon wafer (hereafter, refers “silicon wafer” as “wafer”), equipment of face-down method in which the wafer, directed downward, is immersed has been well known.

FIG. 27 is a vertical section of typical face-down type plating equipment. For instance, in the following ways, the plating can be implemented on a wafer W by means of plating equipment 200 shown in FIG. 27. First, a plating solution is accommodated in a plating solution bath 201 of which upper portion is opened, and the wafer W is held level by a holder 202 with a surface being plated of the wafer W directed downward. Then, in this state, the wafer W is immersed in the plating solution, and between an anode 203 and the wafer W a voltage is applied to implement the plating on the surface being treated of the wafer W. The method, being advantageous in downsizing the plating equipment 200, is in broad use.

In order to implement uniform plating on the wafer W, an entire surface being plated of the wafer W is necessary to be brought into contact with the plating solution. In this case, bubbles or the like have to be prevented from intervening between the surface being plated and the plating solution. However, in view of a structure where the wafer W is brought into contact with the plating solution with the surface being treated thereof W directed downward, the bubbles tend to occur between the surface being plated of the wafer W and the plating solution.

Accordingly, in the plating equipment 200 as mentioned above, the wafer W, after bringing into contact with the plating solution, is rotated in a level plane to remove the bubbles adsorbed on the surface being plated of the wafer W therefrom.

However, in the plating equipment 200 as mentioned above, it is difficult to remove sufficiently the bubbles from the surface being plated of the wafer W.

### SUMMARY OF THE INVENTION

An object of the present invention is to provide liquid treatment equipment capable of removing assuredly bubbles adsorbed on a surface being plated of a substrate therefrom.

Another object of the present invention is to provide liquid treatment equipment in which bubbles are generated with difficulty and a liquid treatment method therefor.

To attain the aforementioned objects, liquid treatment equipment of the present invention comprises a treatment solution bath, a holder, and an annular seal member. The treatment solution bath accommodates a treatment solution. The holder holds a substrate and brings a surface being treated of the substrate into contact with the treatment solution. The annular seal member seals between the surface being treated of the substrate and the holder. Here, in a sealed state, at a boundary portion between an inner periphery surface of the seal member and a contact surface in contact with the surface being treated of the substrate, a brim portion of a radius of curvature of 0.5 mm or less exists.

In the liquid treatment equipment of the present invention, there exists the annular seal member between the surface being treated of the substrate and the holder. Wherein, in a sealed state, at a boundary portion between the inner periphery surface of the seal member and a contact surface in contact with the surface being treated of the substrate, a brim portion of a radius of curvature of 0.5 mm or less exists. Accordingly, in a sealed state, between the brim portion and the surface being treated of the substrate, bubbles accumulate with difficulty. As a result, the bubbles adsorbed on the surface being treated of the substrate can be assuredly removed therefrom.

In addition, the above liquid treatment equipment is preferable to be formed so that the contact surface is an approximate plane, and the inner periphery surface is an approximate plane and approximately vertical to the contact surface. By means of the seal member having such contact surface and inner periphery surface, in a sealed state, the brim portion can be assuredly formed.

In the aforementioned liquid treatment equipment, the contact surface is preferable to be formed with a radius of curvature of 0.1 mm or more. By means of the seal member having such contact surface, in a sealed state, the brim portion can be assuredly formed.

Furthermore, the aforementioned liquid treatment equipment is preferable to comprise further a suction member for sucking either one of a gas and bubbles in the neighborhood of the surface being treated of the substrate. By providing such suction member, the gas in the neighborhood of the surface being treated of the substrate can be removed. Accordingly, when the surface being treated of the substrate is brought into contact with a liquid level of the treatment solution, the bubbles are generated with difficulty. In addition, the bubbles present in the neighborhood of the surface being treated of the substrate can be assuredly removed.

Another liquid treatment equipment of the present invention comprises a treatment solution bath, a holder, a first electrode, a second electrode and an annular seal member. In the above, the treatment solution bath accommodates a treatment solution. The holder holds a substrate and brings the surface being treated of the substrate into contact with the treatment solution. The first electrode is disposed in the holder and comes into contact with the surface being treated of the substrate. The second electrode is disposed in the treatment solution bath and applied a voltage between the first electrode. The annular seal member comprises an inside seal portion disposed more inside than a contact portion to seal the contact portion between the first electrode and the surface being treated of the substrate and an outside seal portion disposed more outside than the contact portion. Here, in a sealed state, at a boundary portion between an inner periphery surface of the inside seal portion and a contact surface in contact with the surface being treated of the substrate, a brim portion of a radius of curvature of 0.5 mm or less exists.

The liquid treatment equipment of the present invention comprises the annular seal member comprising the inside seal portion disposed more inside than the contact portion to seal the contact portion between the first electrode and the surface being treated of the substrate, and an outside seal portion disposed more outside than the contact portion. In addition, in a sealed state, at a boundary portion between the inner periphery surface of the inside seal portion and the contact surface in contact with the surface being treated of the substrate, there is provided with a brim portion of a radius of curvature of 0.5 mm or less. Accordingly, in a sealed state, the bubbles accumulate between the brim portion and the surface being treated of the substrate with difficulty. As a result, the bubbles adsorbed on the surface being treated of the substrate can be assuredly removed therefrom.

Furthermore, the liquid treatment equipment is preferable to be formed so that the contact surface is an approximate plane, and the inner periphery surface is an approximate plane and vertical to the contact surface. By means of the seal member having such contact surface and inner periphery surface, in a sealed state, the brim portion can be assuredly formed.

Furthermore, the above liquid treatment equipment is preferably formed so that the contact surface is a radius of curvature of 0.1 mm or more. By means of the seal member having such contact surface, in a sealed state, the brim portion can be assuredly formed.

Still furthermore, in the aforementioned liquid treatment equipment, the seal member is preferably provided with a leading path formed over from the inside seal portion to the outside seal portion. By providing such leading path, the bubbles come out through the leading path. Accordingly, the bubbles adsorbed on the surface being treated of the substrate can be assuredly removed therefrom.

Furthermore, in the liquid treatment equipment, the holder can be further provided with a rear surface cover for covering a rear surface of the substrate. By disposing such rear surface cover, the rear surface of the substrate can be protected. As a result, irrespective of whether the surface being treated of the substrate is directed upward or downward with respect to the treatment solution, the liquid treatment can be applied on the surface being treated of the substrate.

Still furthermore, the liquid treatment equipment is preferably provided with a suction member disposed to the holder and sucking either one of a gas and bubbles in the neighborhood of the surface being treated of the substrate. By disposing such suction member, since the gas in the neighborhood of the surface being treated of the substrate can be removed, when the surface being treated of the substrate is brought into contact with the liquid level of the treatment solution, the bubbles occur with difficulty. In addition, the bubbles adsorbed on the surface being treated of the substrate can be assuredly removed therefrom.

Still another liquid treatment equipment of the present invention comprises a treatment solution bath, a holder, a first electrode, a second electrode and a suction member. In the above, the treatment solution bath accommodates a treatment solution. The holder holds a substrate and brings the surface being treated of the substrate into contact with the treatment solution. The first electrode is disposed in the holder and comes into contact with the surface being treated of the substrate. The second electrode is disposed in the treatment solution bath and applied a voltage between the first electrode. The suction member is disposed to the holder and sucks either one of the gas and bubbles in the neighborhood of the surface of the substrate.

Here, the liquid treatment equipment of the present invention is provided with the suction member that is disposed to the holder and sucks either one of the gas and bubbles in the neighborhood of the surface of the substrate. Accordingly, since the gas in the neighborhood of the surface being treated of the substrate can be removed, when the surface being treated of the substrate is brought into contact with the liquid level of the treatment solution, the bubbles are generated with difficulty. In addition, the bubbles adsorbed on the surface being treated of the substrate can be assuredly removed therefrom.

Furthermore, in the liquid treatment equipment, the suction member is preferable to have a venturi tube and a gas supply unit for supplying a gas to the venturi tube. By disposing such venturi tube and gas supply unit, the gas or bubbles can be efficiently sucked with a simple structure.

Still furthermore, in the liquid treatment equipment, the venturi tube is preferable to be a double venturi tube. By disposing the double venturi tube, a suction power can be increased. Furthermore, the treatment solution containing the bubbles goes through the neighborhood of a center of the double venturi tube. Accordingly, the treatment solution can be reduced in an amount adsorbed on an inner wall of the venturi tube. As a result, the treatment solution adsorbed on an inner wall of the venturi tube is prevented from drying to decrease the suction power.

A liquid treatment method of the present invention comprises a step of immersing where, a surface being treated of a substrate, directed downward, while sucking a gas in the neighborhood thereof, is brought into contact with a liquid level of a treatment solution to immerse in the treatment solution, and a step of liquid treating where, after immersing the surface being treated of the substrate in the treatment solution, an electric current is sent to the substrate to implement the liquid treatment to the surface being treated of the substrate.

The present liquid treatment method is provided with the step of immersing. In the step of immersing, the surface being treated of the substrate, directed downward, while sucking a gas in the neighborhood of the surface being treated of the substrate, is brought into contact with the liquid level of the treatment solution to immerse in the treatment solution. Accordingly, the gas in the neighborhood of the surface being treated of the substrate can be removed. As a result, when bringing the surface being treated of the substrate into contact with the treatment solution, the bubbles occur with difficulty.

Furthermore, in the above liquid treatment method, the step of immersing is one in which, the surface being treated of the substrate, after being brought into contact with the liquid level of the treatment solution, while sucking the bubbles in the neighborhood of the surface of the substrate, is immersed. By the use of such step of immersing, even when the bubbles occur and are adsorbed on the surface being treated of the substrate, the bubbles can be assuredly removed from the surface being treated of the substrate.

A liquid treatment method of the present invention comprises a step of immersing a surface being treated of a substrate in a treatment solution and a step of implementing liquid treatment on the surface being treated of the substrate. In the step of immersing, a surface being treated of a substrate, directed downwardly, after being brought into contact with the liquid level of the treatment solution, while sucking the bubbles in the neighborhood of the surface being treated of the substrate, is immersed. In the step of implementing the liquid treatment on the surface of the substrate, after immersing the surface being treated of the substrate in the treatment solution, an electric current is sent to the substrate to implement the liquid treatment on the surface being treated of the substrate.

In the present liquid treatment method, in the step of immersing, the surface of the substrate that is held downwardly, after being brought into contact with the liquid level of the treatment solution, while sucking the bubbles in the neighborhood thereof, is immersed. Accordingly, the bubbles adsorbed on the surface being treated of the substrate can be assuredly removed therefrom.

Still another liquid treatment method comprises the steps of sucking, with a surface being treated of a substrate directed downward and immersed in a treatment solution, bubbles in the neighborhood of the surface being treated of the substrate, and of sending an electric current, after sucking the bubbles, to the substrate to implement the liquid treatment to the surface being treated of the substrate.

In the liquid treatment method of the present invention, with the surface being treated of the substrate directed downwardly and immersed in the treatment solution, the bubbles in the neighborhood of the surface being treated of the substrate are sucked. Accordingly, the bubbles adsorbed on the surface of the substrate can be assuredly removed therefrom.

### BRIEF DESCRIPTION OF THE DRAWINGS

FIG. 1 is a perspective view showing schematically a plating system involving a first embodiment.

FIG. 2 is a plan view showing schematically a plating system involving a first embodiment.

FIG. 3 is a front view showing schematically a plating system involving a first embodiment.

FIG. 4 is a side view showing schematically a plating system involving a first embodiment.

FIG. 5 is a vertical section showing schematically a plating unit involving a first embodiment.

FIG. 6 is a vertical section showing schematically a holder involving a first embodiment.

FIG. 7A is a plan view showing schematically a seal member involving a first embodiment.

FIG. 7B is a vertical section showing schematically a seal member involving a first embodiment.

FIG. 8 is an enlarged vertical section showing schematically a seal member involving a first embodiment.

FIG. 9 is a flow chart showing an entire flow of a plating system involving a first embodiment.

FIG. 10 is a flow chart showing a flow of plating process carried out in a plating unit involving a first embodiment.

FIGS. 11A through 11P are vertical sections showing schematically plating process involving a first embodiment.

FIG. 12A is a state diagram when sealed with a seal member involving a first embodiment.

FIG. 12B is a state diagram when a holder involving a first embodiment is immersed in a plating solution.

FIG. 13 is an enlarged vertical section showing schematically a seal member involving a second embodiment.

FIG. 14A is a plan view of a seal member involving a third embodiment.

FIG. 14B is a vertical section showing schematically a seal member involving a third embodiment.

FIG. 15 is a perspective view of a holder involving a third embodiment.

FIG. 16 is a vertical section showing schematically part of the inside of a plating unit involving a fourth embodiment.

FIG. 17 is an enlarged vertical section showing schematically a holder involving a fifth embodiment.

FIG. 18 is a schematic vertical section of a plating unit involving a sixth embodiment.

FIG. 19 is a horizontal section showing schematically a holder equipped with a venturi tube involving a sixth embodiment.

FIG. 20 is a vertical section showing schematically a holder equipped with a venturi tube involving a sixth embodiment.

FIG. 21 is a flow chart showing a flow of plating process implemented in a plating unit involving a sixth embodiment.

FIG. 22 is a schematic state diagram when a holder equipped with a venturi tube involving a sixth embodiment is immersed in a plating solution.

FIG. 23 is a schematic vertical section of a holder equipped with a double venturi tube involving a seventh embodiment.

FIG. 24 is a schematic state diagram when a holder equipped with a double venturi tube involving a seventh embodiment is immersed in a plating solution.

FIG. 25 is a schematic vertical section of a holder equipped with a single venturi tube involving a modified example.

FIG. 26 is a schematic state diagram when a holder involving a modified example is immersed in a plating solution.

FIG. 27 is a vertical section of an existing plating equipment.

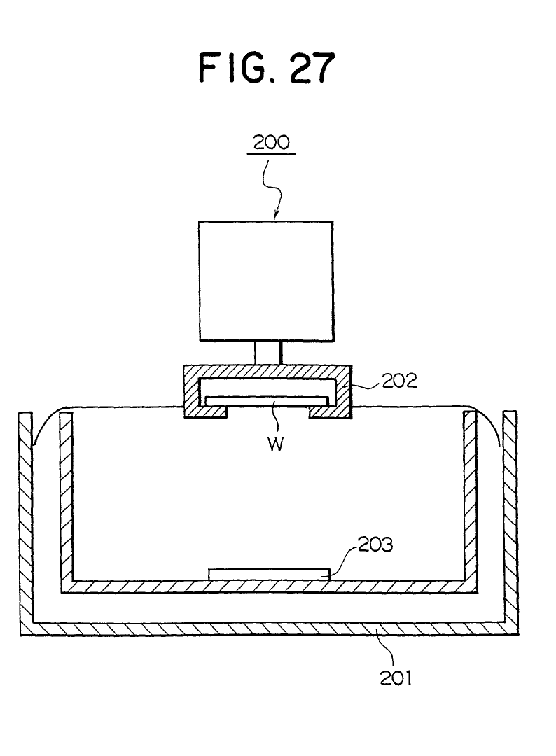

### DESCRIPTION OF PREFERRED EMBODIMENTS

(First Embodiment)

In the following, a plating system involving a first embodiment of the present invention will be explained.

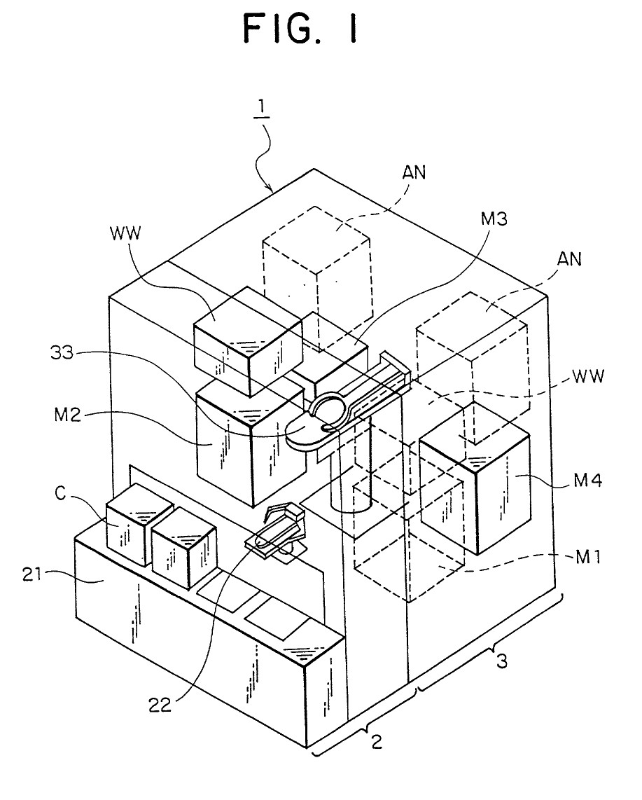

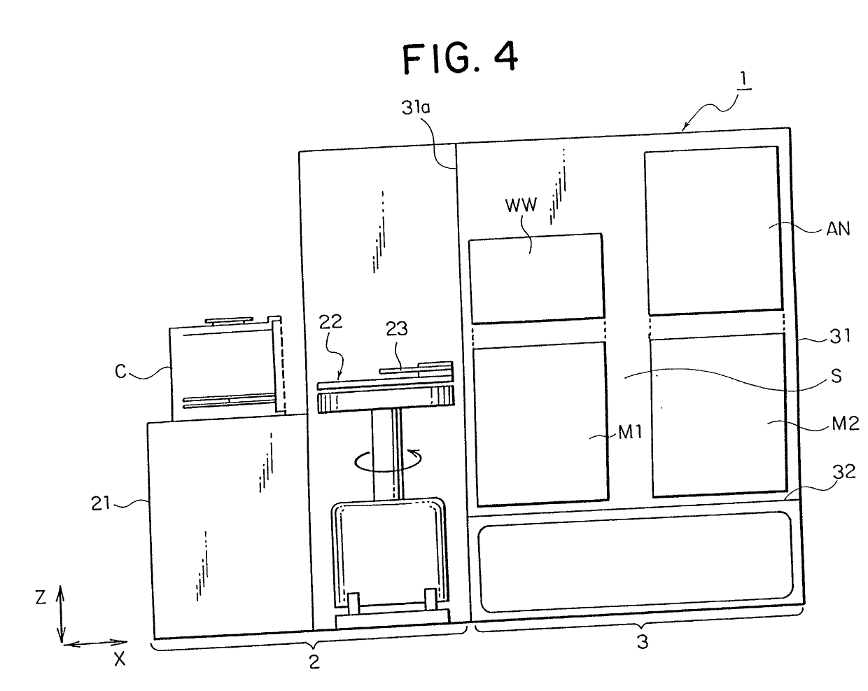

FIGS. 1 through 4 are a perspective view, a plan view, a front view and a side view, respectively, all showing schematically a plating system involving the present embodiment.

As shown in FIGS. 1 through 4, the plating system 1 is constituted of a carrier station 2 for transferring a wafer W and a process station 3 for actually implementing treatment to the wafer W.

The carrier station 2 is constituted of a susceptor 21 for accommodating the wafers W and a sub-arm 22 for taking out an untreated wafer W from a carrier cassette C disposed on the susceptor 21 or accommodating a treated wafer W in the carrier cassette C.

In the carrier cassette C, a plurality, for instance 25 sheets, of wafers W are accommodated approximately level with an equidistance apart.

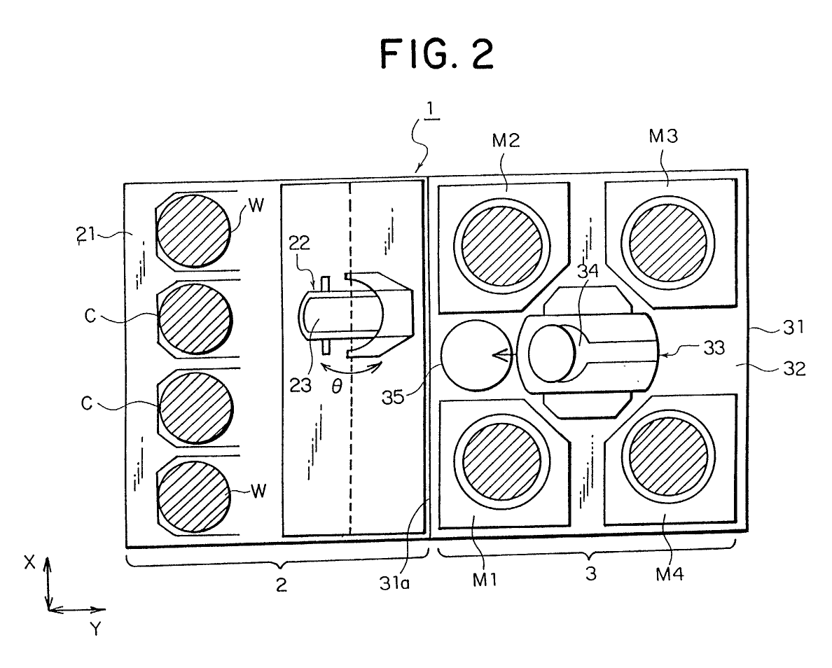

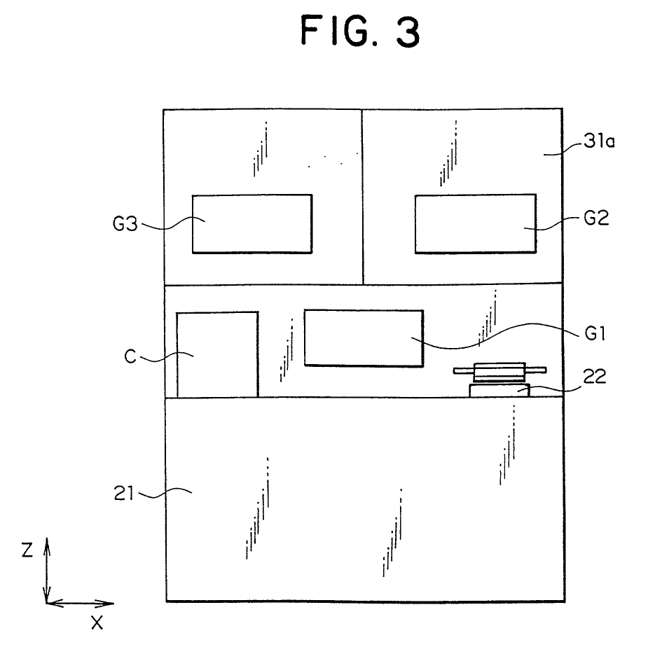

The sub-arm 22 is structured that can move on a rail disposed in an X direction in FIGS. 2 and 3, elevate in a z direction of FIG. 3, that is, in a direction vertical to a paper plane of FIG. 2, and rotate in a level plane. The sub-arm 22 is provided with a wafer hold member 23 extensible in an approximate level plane. By extending the wafer hold member 23, a wafer W can be taken out of the carrier cassette C disposed on the susceptor 21, and can be accommodated into the carrier cassette C.

Furthermore, the sub-arm 22, also between the process station 3 described below, can deliver the wafer W before and after the treatment.

The process station 3, as shown in FIGS. 1 through 4, has an appearance of a box of rectangular parallelepiped or cube, an entire surroundings thereof being covered by a housing 31 formed of corrosion resistant material, for instance, resin or a metal plate of which surface is coated by resin.

Inside the housing 31, a treatment space S is formed, at the base thereof S a bottom plate 32 being attached.

Furthermore, in the treatment space S, a plurality of treatment units, for instance four sets of plating units M1 through M4, are disposed in the surroundings of a main-arm 33 described below, respectively.

At an approximate center of the bottom plate 32, as shown in FIGS. 1 and 2, the main-arm 33 is disposed to transfer the wafer W. The main-arm 33 is structured that can elevate and rotate in a level plane. In addition, the main-arm 33 is provided with two upper and lower wafer hold members 34 extensible in an approximately level plane. By extending the wafer hold members 34, with respect to the treatment units disposed in the surroundings of the main-arm 33, the wafers before and after the treatment can be sent in and out.

Furthermore, the main-arm 33 is provided with a function to reverse the held wafer W up and down to reverse the wafer W up and down during the transfer of the wafer W from one treatment unit to another treatment unit. The function to reverse the wafer W up and down is not an indispensable one.

Above the plating units M1 and M2, other treatment units, for instance two sets of cleaning units WW, are disposed, respectively. Furthermore, above the plating units M3 and M4, for instance two sets of annealing units AN are disposed, respectively. A plurality of treatment units are disposed in multi-stages in an up and down direction, accordingly an area efficiency of the plating system 1 can be improved.

In addition, in the housing 31, a middle susceptor 35 is disposed to temporarily dispose the wafer W.

Furthermore, of the housing 31 of the process station 3, in a wall surface 31a disposed at a position facing to the carrier station 2, as shown in FIG. 3, three openings G1 through G3 that can be opened are formed. Among these, the opening G1, formed between the plating units M1 and M2, is used to send an untreated wafer W taken out of the carrier cassette C by the sub-arm 22 in the process station 3. When sending in, the opening G1 is opened and the sub-arm 22 holding an untreated wafer W dispose the wafer W on the middle susceptor 35. Then, the main-arm 33 extends to the middle susceptor 35 to hold the wafer W and transfers to the respective treatment units such as the plating units M1 through M4.

Remaining openings G2 and G3 are formed in the neighborhood of the cleaning unit WW, respectively. Through these openings G2 and G3, the sub-arm 22 receives the wafer W treated in the cleaning unit WW. Accordingly, the wafer W cleansed in the cleaning unit WW is prevented from coming into contact with the contaminated main-arm 33.

Furthermore, in the treatment space S, an airflow is formed downwardly from above to below. That is, a clean air supplied from above the treatment space S flows down toward the cleaning unit WW and the plating units M1 through M4, and is exhausted from the bottom of the treatment space S outside the plating system 1. Thus, by sending the clean air in the treatment space S from above to below, there is no airflow from the plating units M1 through M4 on the lower tier side toward the cleaning unit WW on the upper tier side. Accordingly, the cleaning unit WW side is always kept in a clean atmosphere.

Furthermore, the insides of the respective treatment units such as the plating units M1 through M4 and the cleaning unit WW are maintained in a lower pressure than that of the treatment space S of the plating system 1. As a result, the airflow is directed from the treatment space S to the respective treatment units. Accordingly, contamination can be prevented from diffusing from the respective treatment unit sides to the treatment space S side. The air flowed into the respective treatment units is exhausted from the respective treatment units outside the plating system 1.

In addition, the plating units M1 through M4 each can be independently operated and are constituted to be separately detachable. Accordingly, when one plating unit cannot be operated due to maintenance purpose or the like, another plating unit can be operated instead.

Next, the plating unit M1 involving the present embodiment will be explained.

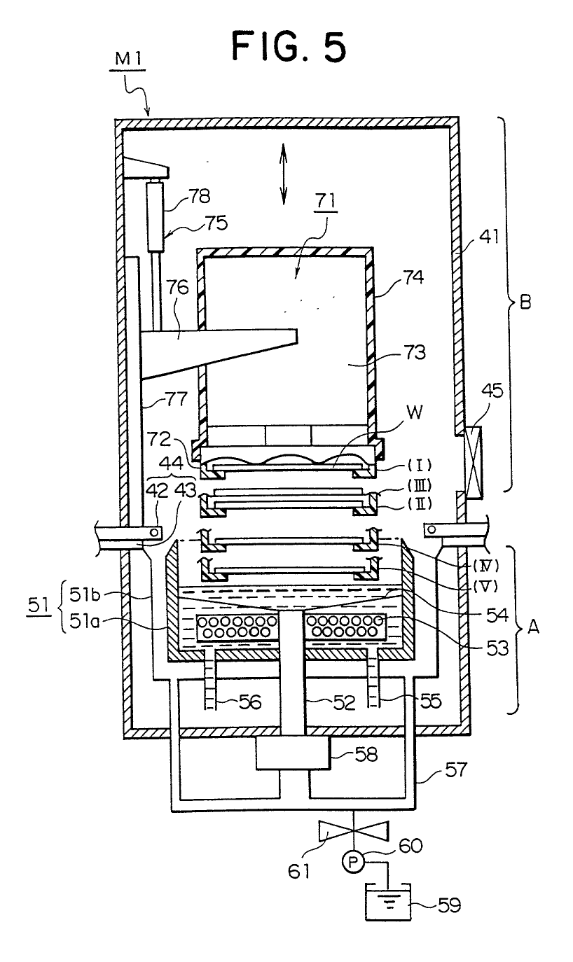

FIG. 5 is a vertical section showing schematically the plating unit M1 involving the present embodiment.

As shown in FIG. 5, as to the plating unit M1, an entirety thereof M1 is covered by an airtight housing 41. The housing 41 is constituted of corrosion resistant material such as resin or the like.

The inside of the housing 41 is divided into two tiers of above and below, that is, a first treatment portion A positioned on the lower tier and a second treatment portion B positioned on the upper tier.

The first and second treatment portions A and B are partitioned by a separator 44 incorporating a plurality of cleaning nozzles 42 and an outfall 43 disposed thereunder. Accordingly, the contamination can be prevented from diffusing from the first treatment portion A side to the second treatment portion B side on the upper tier.

The outfall 43 is connected to an exhaust system not shown in the figure, the plating solution, vaporized mist and scattered mist being sucked to exhaust outside the plating system 1. Furthermore, due to the sucking of the outfall 43, the impurities also can be exhausted outside the plating system 1, thus enabling to maintain the inside of the plating unit M1 a clean atmosphere.

In the center of the separator 44, there is formed a through hole, therethrough the wafer W held by a driver 71 described below coming and going between the first and second treatment portions A and B.

Still furthermore, in the housing 41 in the neighborhood of a transfer position (I) described below, a gate valve 45 is disposed to send the wafer W in and out of the plating unit M1. When the gate valve 45 is closed, the inside of the plating unit Ml is isolated from the treatment space S, resulting in preventing the contamination from diffusing from the plating unit M1 to the outside treatment space S.

In the first treatment portion A, there is disposed a plating solution bath 51 as a treatment solution bath. The plating solution bath 51 is constituted of an inner bath 51a and an outer bath 51b disposed outside the inner bath 51a concentrically with the inner bath 51a.

The inner bath 51a is structured into an approximate cylinder with an opened upper surface and a closed lower surface, the open surface of the inner bath 51a being maintained approximately level. In addition, the inner bath 51a is fixed so that, when the inner bath 51a is filled by the plating solution, the surface being plated of the wafer W positioned at a plating position (V) described below is lower than the liquid level of the plating solution.

In the inner bath 51a, an ejection nozzle 52 is projected from the center of the bottom surface of the inner bath 51a up to the neighborhood of an approximate middle in a depth direction of the inner bath 51a to eject the plating solution from the bottom surface of the inner bath 51a toward the upper surface thereof.

Still furthermore, in the surroundings of the ejection nozzle 52, there is disposed, concentrically with the inner bath 51a, an anode 53 as a second electrode that is an approximate disc formed by collecting for instance a plurality of copper balls. The anode 53 dissolves gradually by the application of a voltage. As a result, copper ions in the plating solution containing for instance copper sulfate can be prevented from decreasing. In addition, the anode 53 is electrically connected to an external power source not shown in the figure.

Between an end periphery of the ejection nozzle 52 and inner bath 51a, a membrane 54 is disposed above the anode 53 to partition the inner bath 51a into two of above and below. The membrane 54 is so constituted that ions are allowed to permeate but impurities generated when the anode 53 is dissolved, or bubbles such as for instance oxygen and hydrogen generated during the plating are not allowed to permeate. In an upper side area of the inner bath 51a partitioned by the membrane 54, the plating solution is supplied from the ejection nozzle 52. Furthermore, into a lower side area of the inner bath 51a partitioned by the membrane 54, from circulation piping 55 described below, the plating solution is supplied.

At positions eccentric from the center of the bottom surface of the inner bath 51a, there are disposed circulation piping 55 and 56. In addition, between the circulation piping 55 and 56, there is disposed a pump not shown in the figure to circulate the plating solution in the lower side area of the inner bath 51a.

The outer bath 51b, similarly with the inner bath 51a, is formed in an approximate cylinder with an open upper surface and a closed bottom surface, the open surface of the outer bath 51b being maintained approximately level.

There are disposed outfalls at two positions of the bottom of the outer bath 51b, thereto piping 57 being connected. Furthermore, between the piping 57 and the ejection nozzle 52, there is disposed a pump 58. Still furthermore, to the piping 57, a tank 59 accommodating the plating solution is connected through a pump 60 and a valve 61. By operating the pump 60 and opening the valve 61, the plating solution in the tank 59 is supplied through the ejection nozzle 52 into the upper side area of the inner bath 51a.

In the second treatment portion B, a driver 71 is disposed immediately above the center of the plating solution bath 51. The driver 71 is constituted of a holder 72 holding the wafer W and a motor 73 rotating the wafer W together with the holder 72 in an approximately level plane.

The motor 73 is covered by a cover 74 made of corrosion resistant material such as resin or the like. Accordingly, the plating solution, evaporated mist and scattered mist can be prevented from intruding into the motor 73.

The motor 73 is given an elevation unit 75 elevating the driver 71 with respect to the plating solution bath 51. The elevation unit 75 is specifically constituted of for instance a support beam 76, a guide rail 77, and a cylinder 78. The support beam 76 is attached to an outside vessel of the motor 73 and supports the driver 71. The guide rail 77 is attached to an inner wall of the housing 41. The cylinder 78 freely extensible in an up and down direction elevates the support beam 76 along the guide rail 77. By driving the cylinder 78, the driver 71 supported by the support beam 76 moves up and down along the guide rail 77 to elevate the wafer W.

Specifically, by means of the elevation unit 75, the wafer W elevates mainly between the following four positions of different heights along a center axis of the plating solution bath 51. These positions are as follows. That is, a transfer position (I) for transfer, a wafer cleaning position (II) for cleaning the plating applied to the wafer W with a cleaning fluid such as for instance purified water, a contact cleaning position (III) for cleaning a contact 84 described below with a cleaning fluid such as purified water, a spin-dry position (IV) for spin-drying to remove excess plating solution and moisture, and a plating position (V) for implementing the plating on a surface being treated of the wafer W. Among these, the transfer position (I), the wafer cleaning position (II), and the contact cleaning position (III) are all positioned above the liquid level of the plating solution when the plating solution is filled to the brim of the plating solution bath 51. The spin-dry position (IV) and plating position (V) are positioned below the liquid level of the plating solution.

Next, the holder 72 involving the present embodiment will be explained.

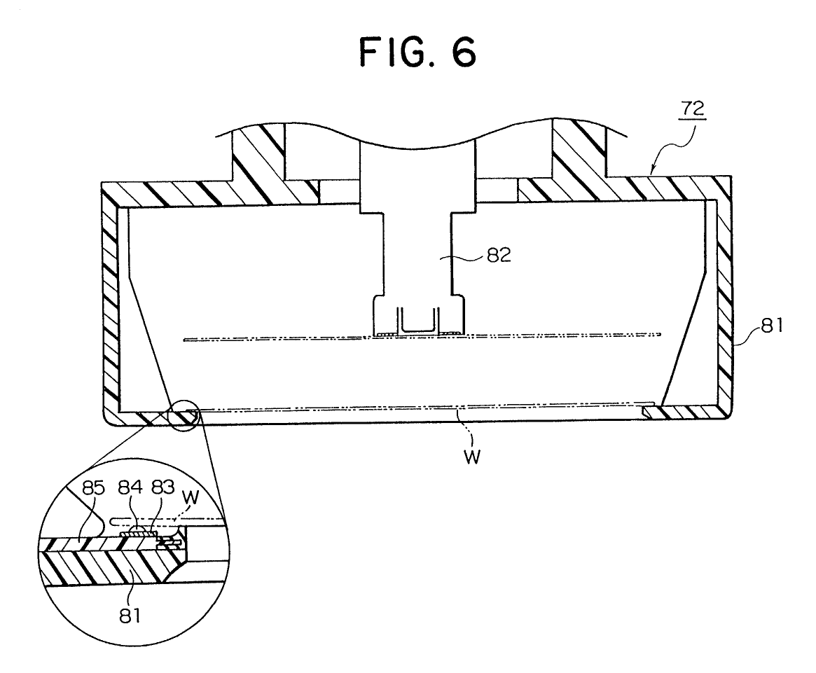

FIG. 6 is a vertical section showing schematically the holder 72 involving the present embodiment.

As shown in FIG. 6, the holder 72, provided with an approximately cylindrical holder vessel 81 with closed upper and lower surfaces, holds one sheet of wafer W approximately level in the holder vessel 81. In the bottom surface of the holder vessel 81, there is formed an approximately circular opening, the surface being treated of the wafer W being plated there.

Inside the holder 72, there is disposed a chuck member 82 for sucking a rear surface of the wafer W of which surface being treated is directed downward to elevate the wafer W alone. By operating the chuck member 82, without changing the height of the holder 72, only the height of the wafer W is varied.

On the surface being treated of the wafer W, by the use of a film deposition device disposed in a separate system, for instance a physical vapor deposition (PVD) device, a thin film of the same material with the plating, a so-called seed layer, is formed. By the formation of the seed layer, a voltage applied to a cathode 83 described below can be applied also to the surface being treated of the wafer W.

In addition, inside the holder vessel 81, there is disposed an annular cathode 83 to supply electricity to the surface being treated of the wafer W. The cathode 83 is electrically connected to an external power source not shown in the figure. Furthermore, on the cathode 83, for instance at 128 positions divided with an equidistance apart, semispherical contacts 84 are projected to bring into contact with a periphery of the surface being treated of the wafer W. By forming the contacts 84 semispherically, the contacts 84 each are brought into contact with the wafer W through a definite area.

Still furthermore, between the holder vessel 81 and the cathode 83, there is disposed an annular seal member 85 constituting of for instance resin and rubber partially covering the resin to prevent the plating solution from intruding into the holder vessel 81.

In the following, the seal member 85 involving the present embodiment will be explained.

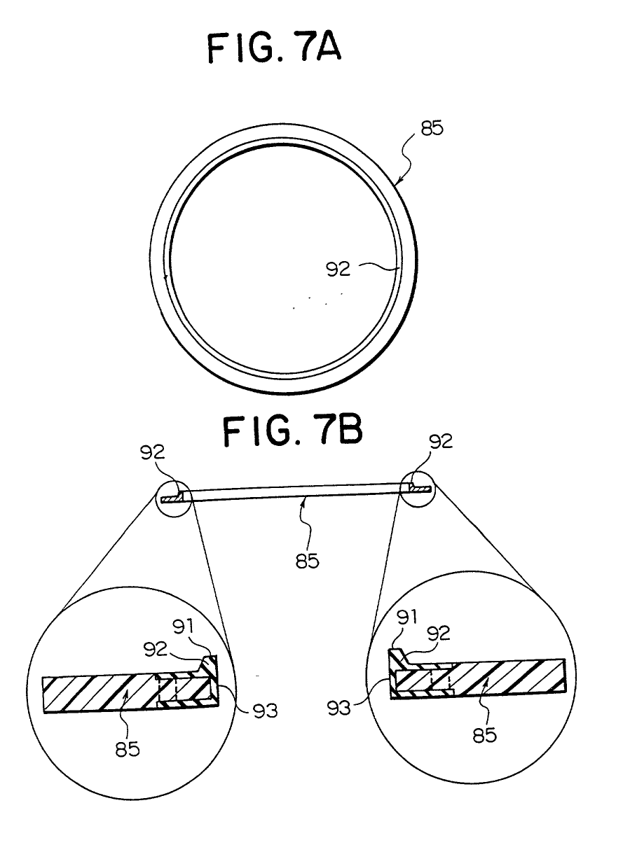

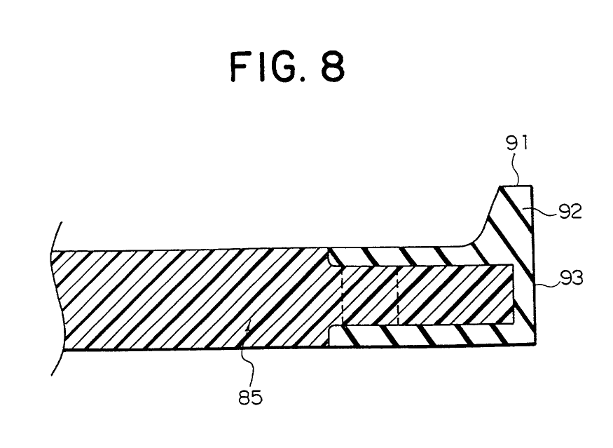

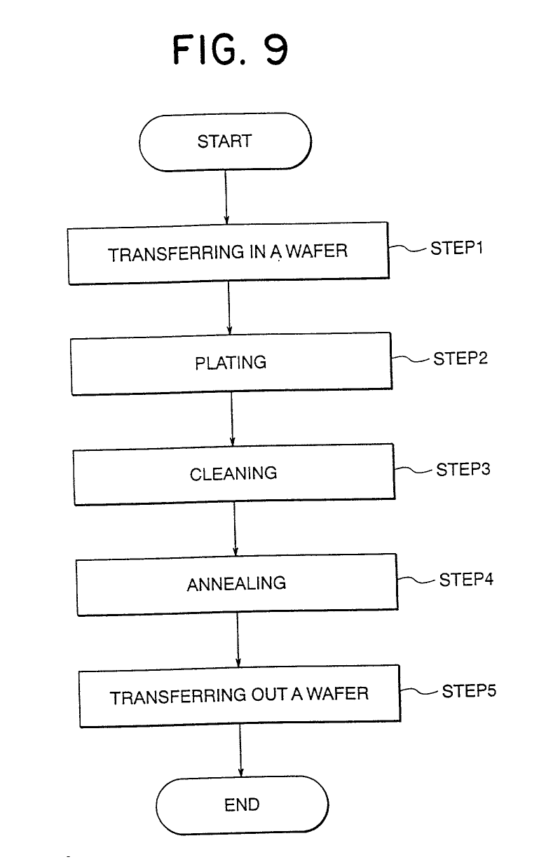

FIG. 7A is a plan view showing schematically the seal member 85 involving the present embodiment, FIG. 7B being a vertical section showing schematically the seal member 85 involving the present embodiment. FIG. 8 is an enlarged vertical section showing schematically the seal member 85 involving the present embodiment.

As shown in FIGS. 7A, 7B and 8, on the inside upper surface of the seal member 85, there is formed a projection 92 having a contact surface 91 coming into contact with the wafer W. The wafer W, disposed on the projection 92 of the seal member 85, is pressed down to elastically deform the seal member 85, thereby sealing between the wafer W and the holder vessel 81.

In the seal member 85 involving the present embodiment, a contact surface 91 thereof is formed in an approximate plane, an inside periphery surface 93 thereof being formed in an approximate plane and approximately vertical to the contact surface 91. Accordingly, when the seal member 85 is pressed down by the wafer W, the contact surface 91 and the surface being treated of the wafer W are brought into intimate contact. Thereby, at a boundary portion between the inside periphery surface 93 of the seal member 85 and the contact surface 91, a brim portion of a radius of curvature of 0.5 mm or less can be formed. An assembly of centers of the radii of curvature forms an annulus of a larger internal diameter than that of the seal member 85.

Furthermore, in a sealed state, it is preferable to have a brim portion of a radius of curvature of 0.3 mm or less. Still furthermore, in a sealed state, it is the most preferable to have a brim portion of a right angle.

Next, a treatment process of an entire plating system 1 involving the present embodiment will be explained.

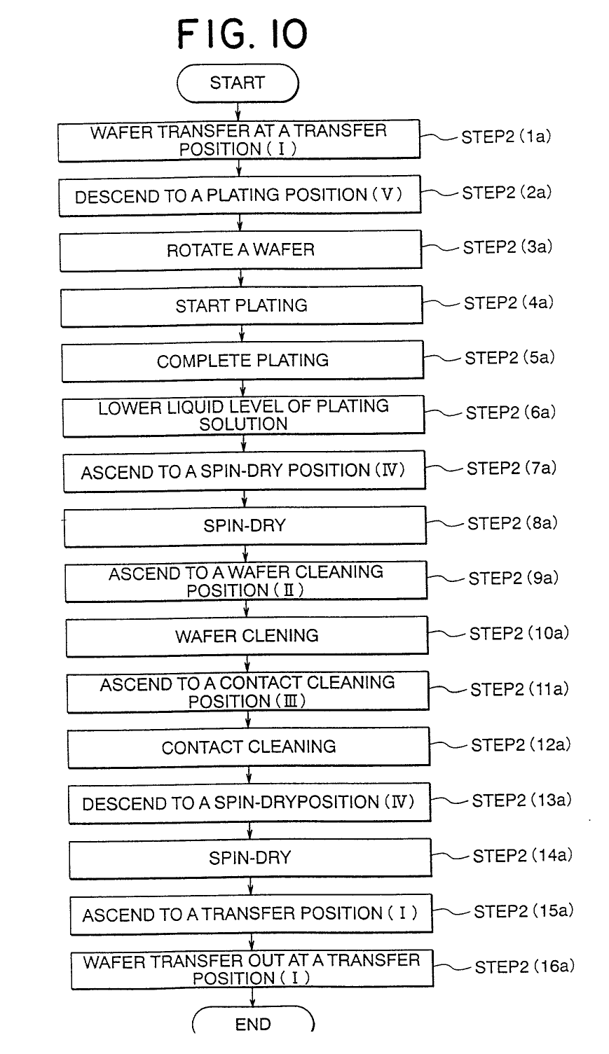

FIG. 9 is a flow chart showing a flow of an entire plating system 1 involving the present embodiment.

As shown in FIG. 9, first, a carrier cassette C accommodating one lot, for instance 25 sheets, of wafers W is disposed on the susceptor 21 by means of a transfer robot not shown in the figure. Upon the disposition of the carrier cassette C, the sub-arm 22 moves itself in front of the carrier cassette C and extends a wafer hold member 23 into the carrier cassette C disposed on the susceptor 21 to take an untreated wafer W therefrom C. Furthermore, the sub-arm 22 revolves and the wafer hold member 23 holding the wafer W extends, through the opening G1, to dispose temporarily the wafer W on the middle susceptor 35. When the wafer W is disposed on the middle susceptor 35, the wafer hold member 34 of the main-arm 33 extends to receive the untreated wafer W on the middle susceptor 35. After receiving the untreated wafer W, the main-arm 33 revolves and the wafer hold member 34 extends to send the wafer W into for instance plating unit M1 (step 1).

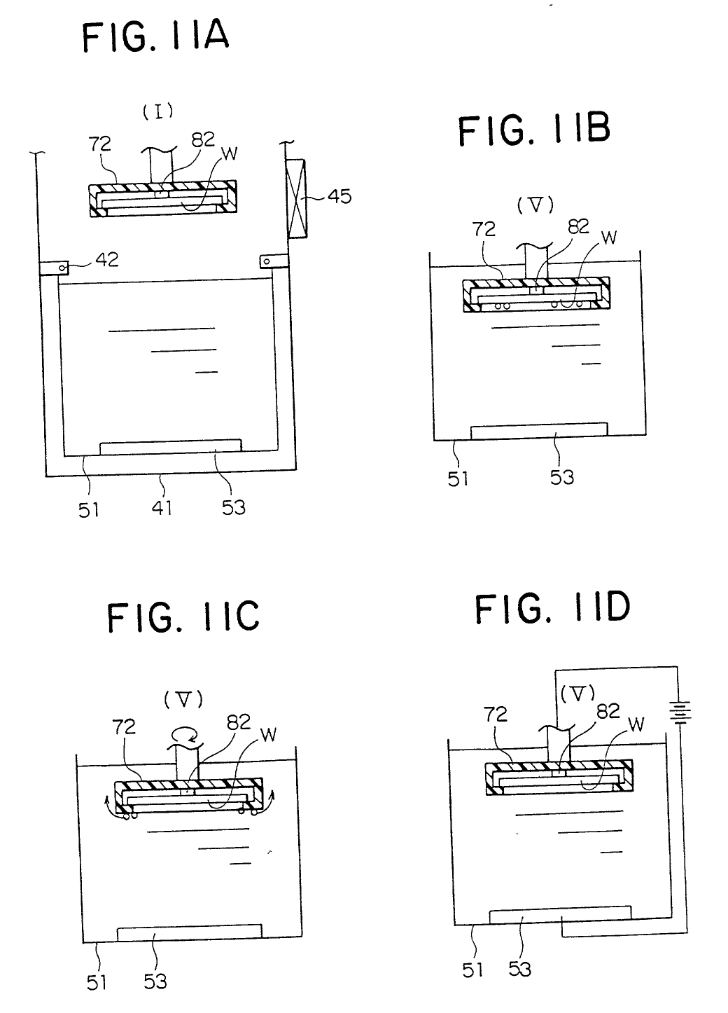

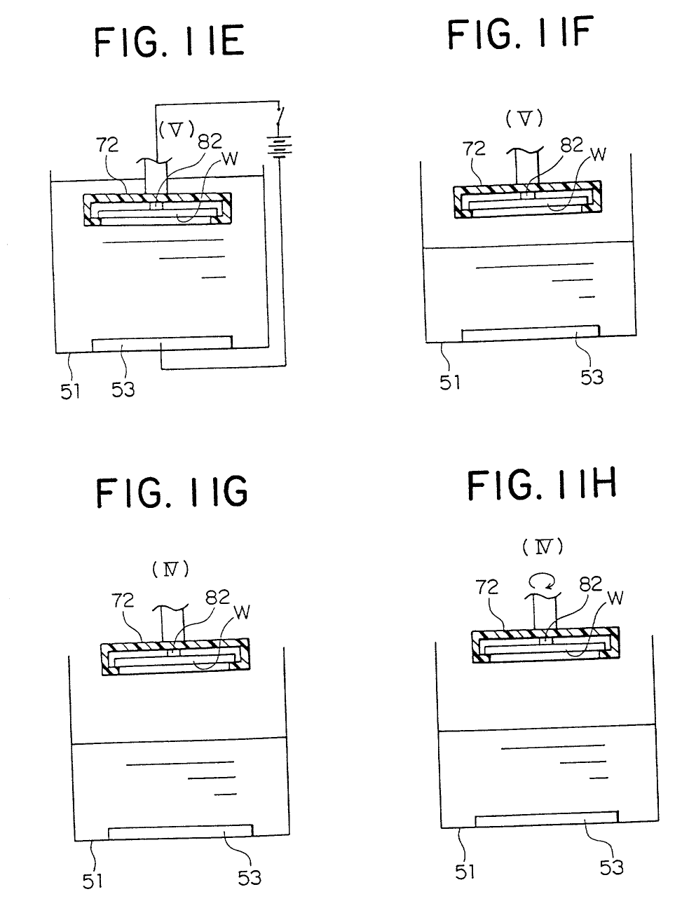

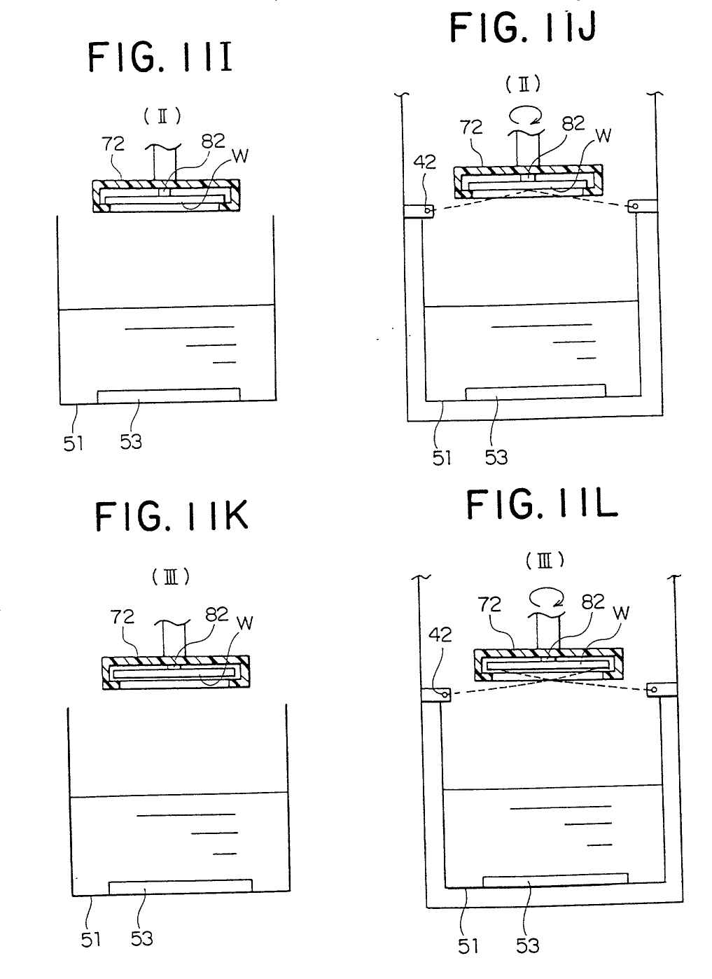

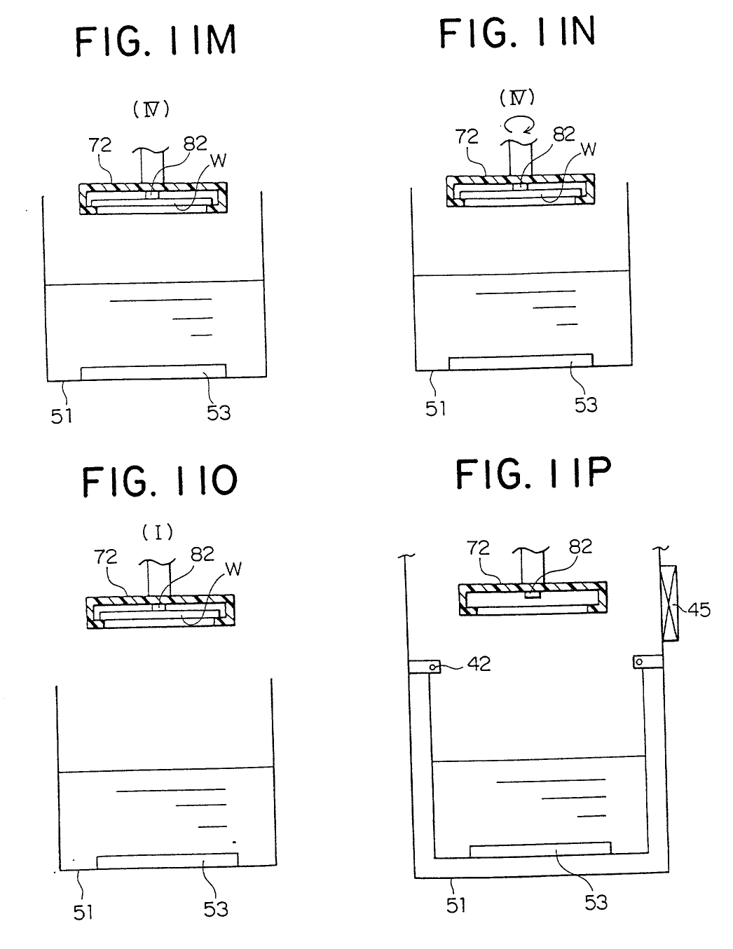

In the following, a flow of the plating process (step 2) carried out in the plating unit M1 will be explained with reference to FIGS. 10 through 12B. FIG. 10 is a flow chart showing a flow of the plating process carried out in the plating unit involving the present embodiment. FIGS. 11A through 11P are vertical sections showing schematically the plating process involving the present embodiment. FIG. 12A is a state diagram when sealed with the seal member 85 involving the present embodiment. FIG. 12B is a state diagram when the holder 72 involving the present embodiment is immersed in the plating solution.

First, the gate valve 45 disposed in a sidewall of the plating unit M1 is opened, the wafer hold member 34 holding an untreated wafer W extending into the plating unit M1. Then, into the holder 72 waiting in the transfer position (I), the wafer W is sent in so that the surface being treated of the wafer W is directed to the liquid level of the plating solution. In this state, the chuck member 82 sucks a rear surface of the wafer W, and the wafer hold member 34 shrinks to deliver the wafer W to the chuck member 82. Thereafter, the chuck member 82 descends to dispose the wafer W on the contact surface 91 of the seal member 85. When the wafer W is disposed on the holder 72, by means of a not shown press member provided in the holder 72, the rear surface of the wafer W is pressed down. Due to the pressing down, the seal member 85 is elastically deformed to seal, as shown in FIG. 11A, between the wafer W and the holder 72 (step 2 (1a)).

In a sealed state, as shown in FIG. 12A, in the seal member 85, at a boundary portion between the inner periphery surface 93 and the contact surface 91 of the seal member 85, a brim portion 94 of a radius of curvature of 0.5 mm or less is formed.

After sealing between the wafer W and the holder 72, the gate valve 45 is closed and the driver 71 is driven by the cylinder 78 to descend, as shown in FIG. 11B, to position the wafer W at the plating position (V) (step 2 (2a)).

When placing the wafer W at the plating position (V), the surface being plated of the wafer W comes into contact with the liquid level of the plating solution. When bringing the wafer W into contact with the liquid level of the plating solution, between the surface being plated of the wafer W and the liquid level of the plating solution, there is a gas such as N₂ or air. Accordingly, due to the above contact, the gas becomes bubbles to be adsorbed on the surface being plated of the wafer W.

Thereafter, in that state, the motor 73 of the driver 71 is driven to rotate the holder 72, as shown in FIG. 1C, in an approximately level plane (step 2 (3a)).

In the present embodiment, in the sealed state, in the seal member 85, at the boundary portion between the inner periphery surface 93 and contact surface 91 of the seal member 85, the brim portion 94 of a radius of curvature of 0.5 mm or less is formed. Accordingly, the bubbles adsorbed on the surface being plated of the wafer W can be assuredly removed therefrom.

That is, by rotating the wafer W, the bubbles adsorbed on the surface being plated of the wafer W are driven toward the outside of a radius of the wafer W to tend to accumulate at a gap between the wafer W and the seal member. The bubbles in the gap can be removed with larger difficulty.

However, in the present embodiment, in the seal member 85, at the boundary portion between the inner periphery surface 93 and contact surface 91 of the seal member 85, the brim portion 94 of a radius of curvature of 0.5 mm or less is formed. Accordingly, the gap between the wafer W and the seal member 85 can be made smaller, the bubbles accumulating there with difficulty.

Furthermore, by rotating the holder 72, a flow of the plating solution directing from the inner periphery surface 93 of the seal member 85 to a bottom of the holder 72 is formed.

As a result, as shown in FIG. 12B, the bubbles present in the neighborhood of the brim portion 94 can be flowed toward the bottom surface of the holder 72. Thereby, the bubbles adsorbed on the surface being plated of the wafer W can be assuredly removed from the surface being plated of the wafer W.

Still furthermore, since the brim portion 94 of the seal member 85 has a radius of curvature of 0.5 mm or less, the plating solution flows smoothly, resulting in easy escape of the bubbles. Accordingly, the bubbles can be efficiently and speedily removed.

After sufficiently removing the bubbles from the surface being plated of the wafer W, a voltage is applied between the anode 53 and cathode 83 to implement, while sending an electric current to the surface being plated of the wafer W as shown in FIG. 1D, the plating on the surface being plated of the wafer W (step 2 (4a)).

In the present embodiment, the bubbles have been assuredly removed from the surface being plated of the wafer W. Accordingly, the plating solution is brought into uniform contact with the surface being plated of the wafer W, thus enabling to implement the uniform plating on the surface being plated of the wafer W.

After plating the surface being plated of the wafer W with a sufficient thickness, as shown in FIG. 11E, the application of the voltage is ceased to stop the formation of the plating (step 2 (5a)).

Subsequently, by the operation of the pump 60 and the release of the valve 61, a prescribed amount of the plating solution is returned to the tank 59, as shown in FIG. 11F, the liquid level of the plating solution in a plating solution bath 51 being lowered (step 2 (6a)).

After lowering the liquid level of the plating solution, the driver 71 is driven by the cylinder 78 to ascend, as shown in FIG. 11G, to place the wafer W at the spin-dry position (IV) (step 2 (7a)).

After moving the wafer W to the spin-dry position (IV), the holder 72 is driven by the motor 73 to revolve in an approximately level plane, thereby spin drying as shown in FIG. 11H (step 2 (8a)).

After sufficiently spin drying, the driver 71 is driven by the cylinder 78 to ascend, as shown in FIG. 11I, to place the wafer W at the wafer cleaning position (II) (step 2 (9a)).

After placing the wafer W at the wafer cleaning position (II), the holder 72 is driven by the motor 73 to revolve in an approximately level plane and the cleaning nozzle 42 ejects purified water to the surface being plated of the wafer W, thereby cleansing the surface being plated of the wafer W as shown in FIG. 11J (step 2 (10a)).

After the completion of the cleaning of the surface being plated of the wafer W, while letting the holder 72 remain there, the chuck member 82 ascends, as shown in FIG. 11K, to place the wafer W at the contact cleaning position (II) (step 2 (11a)).

After placing the wafer W at the contact cleaning position (III), only the holder 72 is driven by the motor 73 to revolve and the cleaning nozzle 42 ejects purified water to the contact 84, thereby cleansing the contact 84 as shown in FIG. 11L (step 2 (12a)).

After the completion of the cleaning of the contact 84, the driver 71 is driven by the cylinder 78 to descend, as shown in FIG. 1M, to place the wafer W at the spin-dry position (IV) (step 2 (13a)).

After the wafer W is lowered to the spin-dry position (IV), the holder 72 is driven by the motor 73 to revolve in an approximately level plane to spin dry as shown in FIG. 11N (step 2 (14a)).

After sufficiently spin-drying, the driver 71 is driven by the cylinder 78 to ascend, as shown in FIG. 110, to place the wafer W at the transfer position (I) (step 2 (15a)).

After placing the wafer W at the transfer position (I), the gate valve 45 is opened and the wafer hold member 34 of the main-arm 33 extends. At the same time when the chuck member 82 stops sucking, the wafer hold member 34 holds the wafer W and retreats from the plating unit M1, thereby, as shown in FIG. 11P, transferring the wafer W out (step 2 (16a)).

After the completion of the plating at the plating unit M1, the wafer W held by the wafer hold member 34, as needs arise, is sent to other plating units M2 through M4 accommodating the plating solutions of different compositions to plate. Similarly, the wafer W is successively transferred to the plating units M2 through M4 accommodating the plating solutions of different compositions to plate.

After the completion of a series of the plating, the wafer hold member 34 holding the wafer W ascends to transfer the wafer W in the cleaning unit WW to cleanse (step 3).

After the completion of the cleaning due to the cleaning unit WW, the wafer W is annealed at the annealing unit AN (step 4).

After the completion of the annealing, the sub-arm 22 again moves itself in front of the process station 3 and simultaneously ascends to a height of the opening G2 or G3. Furthermore, the main-arm 33 receives the annealed wafer W. Then, through the middle susceptor 35 or the inside of the cleaning unit WW, the wafer W is delivered from the main-arm 33 to the sub-arm 22 (step 5).

Thereafter, the sub-arm 22 holding the wafer W descends to a height of the carrier cassette C and moves itself in front thereof C. In that state, the wafer hold member 23 is extended to accommodate the treated wafer W in the carrier cassette C, thereby a series of treatment being finished.

(Second Embodiment)

In the following, a second embodiment of the present invention will be explained. In the following embodiments, the content duplicating with the preceding embodiment may be omitted from explanation.

In the present embodiment, the contact surface of the seal member is constituted to form a radius of curvature of 0.1 mm or more.

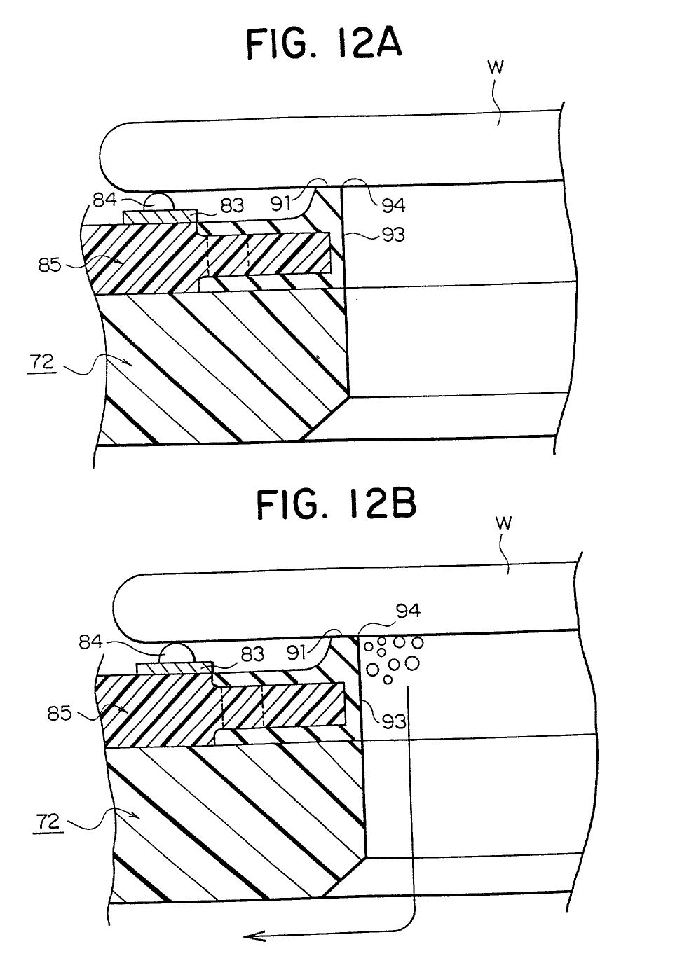

FIG. 13 is an enlarged vertical section showing schematically a seal member 100 involving the present embodiment.

As shown in FIG. 13, a contact surface 101 of the seal member 100 involving the present embodiment is formed in a radius of curvature of 0.1 mm or more.

The reason for constituting the radius of curvature of the contact surface of the seal member 100 in 0.1 mm or more is as follows. That is, when the radius of curvature is less than 0.1 mm, sufficient dimensional accuracy cannot be obtained during the manufacture, resulting in causing problems of stability and reproducibility. Accordingly, there occur problems that assured sealing cannot be obtained.

In the seal member 100 involving the present embodiment, the radius of curvature of the contact surface 101 is formed to be 0.1 mm or more. Accordingly, when disposing the wafer W to press down, the contact surface 101 and the surface being plated of the wafer W can be brought into more intimate contact. In addition, a brim portion of a radius of curvature of 0.5 mm or less can be formed at a boundary portion between an inner periphery surface 102 and the contact surface 101 of the seal member 100. Accordingly, effects identical with the seal member 85 of the first embodiment can be obtained.

(Third Embodiment)

In the following, a third embodiment of the present invention will be explained.

A seal member involving the present embodiment is constituted to have an inside seal portion and an outside seal portion. The inside seal portion is disposed more inside than a contact portion between the contact 84 and the surface being plated of the wafer W, the outside sealing portion being disposed more outside than the contact portion.

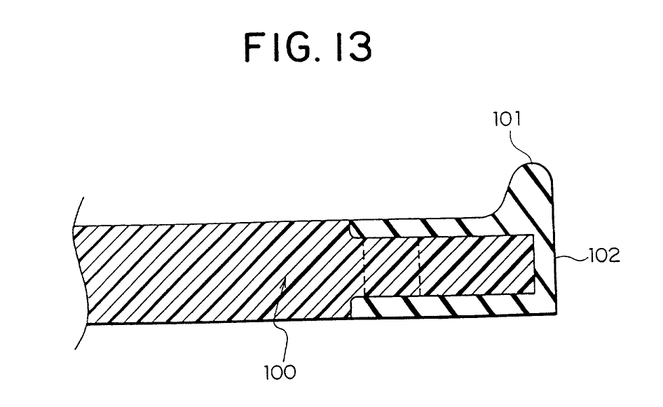

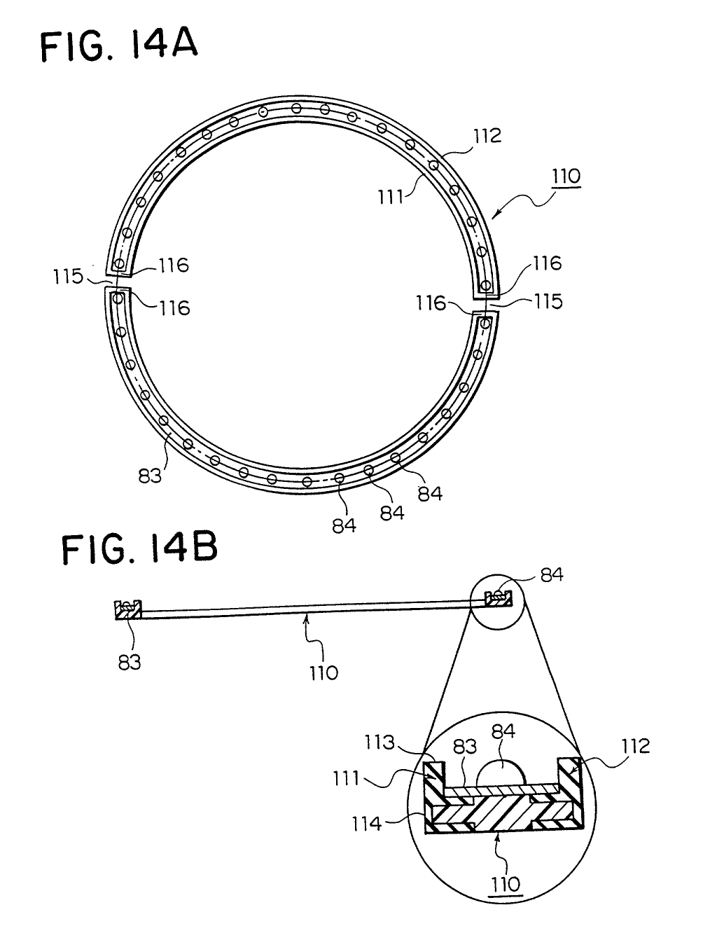

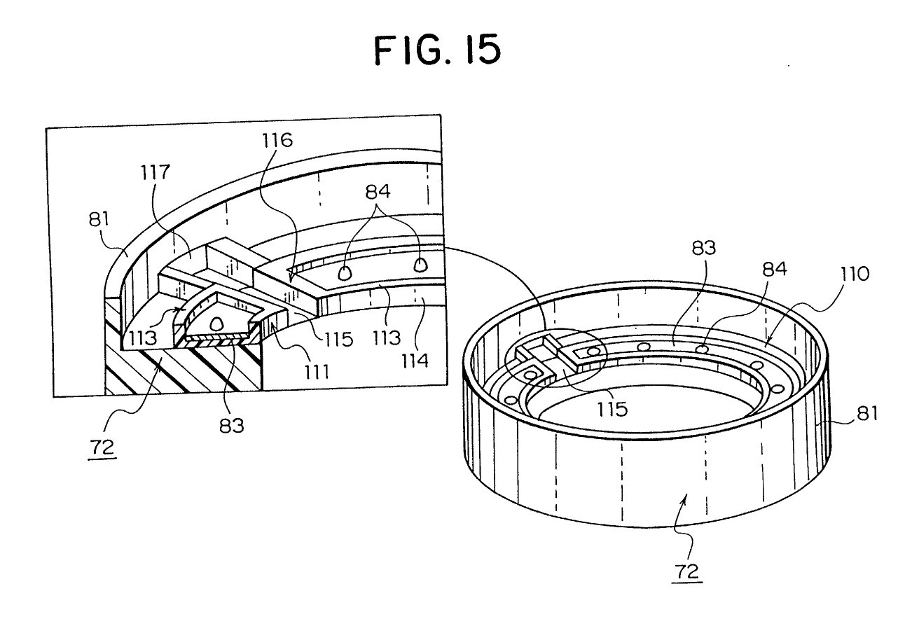

FIG. 14A is a plan view of the seal member involving the present embodiment, FIG. 14B a vertical section showing schematically the seal member involving the present embodiment. FIG. 15 is a perspective view of a holder involving the present embodiment.

As shown in FIGS. 14A, 14B and 15, a seal member 110 involving the present embodiment has an inside seal portion 111 and an outside seal portion 112. The inside seal portion 111 is disposed more inside than the contact portion between the contact 84 and the surface being plated of the wafer. The outside seal portion 112 is disposed more outside than the contact portion.

Furthermore, a contact surface 113 of the inside seal portion 111 that comes into contact with the surface being plated of the wafer W is formed in an approximate plane, an inner periphery surface 114 of the inside seal portion 111 being formed in an approximate plane and approximately vertical with respect to the contact surface 113. Accordingly, when the wafer W is disposed and the inside seal portion 111 is pressed down, the contact surface 113 and the surface being plated of the wafer W are brought into intimate contact. Thereby, a brim portion of a radius of curvature of 0.5 mm or less can be formed at the boundary portion between the inner periphery surface 114 of the inside seal portion 111 and the contact surface 113.

Furthermore, at two positions of the seal member 110 involving the present embodiment, over from the inside seal portion 111 to the outside seal portion 112, leading paths 115 are formed to lead out the bubbles. The leading paths 115 are formed in a radius direction of the seal member 110, on both sides of the leading paths 115 leading path seal member 116 being formed to connect between the inside seal portion 111 and the outside seal portion 112.

In the holder 72 of the present embodiment, an opening 117 connecting with the leading path 115 is formed in a radius direction.

Thus, in the seal member 110 involving the present embodiment, the contact surface 113 of the inside seal portion 111 is formed in an approximate plane, the inner periphery surface 114 of the inside seal portion 111 being formed in an approximate plane and approximately vertical to the contact surface 113. Accordingly, effects similar with that of the first embodiment can be obtained.

Furthermore, the seal member 110, having the inside seal portion 111 disposed more inside than the contact portion between the contact 84 and the surface being plated of the wafer W and the outside seal portion 112 disposed more outside than the contact portion, can assuredly seal the contact portion.

Furthermore, in the seal member 110 involving the present embodiment, over from the inside sealing portion 111 to the outside seal portion 112, the leading path 115 is formed to lead out the bubbles. Accordingly, the bubbles adsorbed on the surface being plated of the wafer W can be assuredly removed therefrom.

That is, when disposing the wafer W on the seal member 110 involving the present embodiment to press down, the inside seal portion 111, the outside seal portion 112 and the leading path seal portion 116 are elastically deformed. Thereby, the leading path 115 in contact with the surface being plated of the wafer W is formed. Then, in a state where the wafer W is placed at the plating position (V), when the holder 72 is rotated in an approximate plane, thereby the plating solution in the neighborhood of the surface being plated of the wafer W flows toward an outside direction of radius of the wafer W. Accordingly, the bubbles adsorbed on the surface being plated of the wafer W can be poured into the leading path 115 together with the plating solution, thereby enabling to push the bubbles through the opening 117 of the holder 72 outside the holder 72. Accordingly, the bubbles adsorbed on the surface being plated of the wafer W can be assuredly removed therefrom.

(Fourth Embodiment)

In the following, a fourth embodiment of the present invention will be explained.

In the present embodiment, a configuration in which a wafer W is plated with a surface being plated thereof directed upward, so-called face up configuration is adopted.

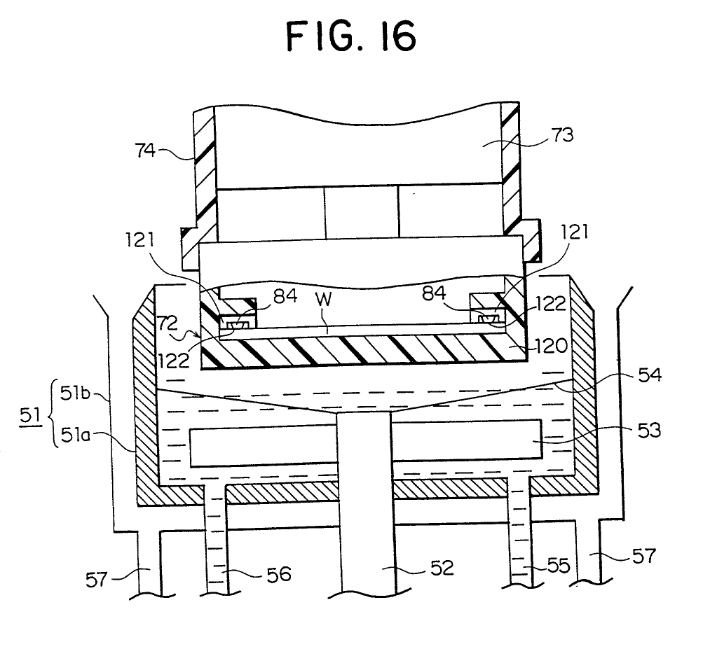

FIG. 16 is a vertical section showing schematically part of the inside of a plating unit 1 involving the present embodiment.

As shown in FIG. 16, the holder 72 involving the present embodiment is equipped with a rear surface cover 120 covering the rear surface of the wafer W to protect.

Furthermore, a seal member 121 involving the present embodiment is the seal member 110 identical with that of the above third embodiment. The seal member 121 is attached so as to cover an outer periphery of the surface being plated of the wafer W. However, in the seal member 121 used in the present embodiment, the leading path leading out the bubbles may not be formed.

With the present embodiment, the effects identical with that of the third embodiment can be obtained.

Furthermore, since the face up method in which the wafer W is plated with the surface being plated thereof directed upward is adopted, the bubbles adsorbed on the surface being plated of the wafer W can be reduced.

Furthermore, since the surface being plated is directed upward, the bubbles, even when adsorbed on the surface being plated of the wafer W, can be removed with ease therefrom.

Still furthermore, the seal member 121 surrounds a circumference of the contact 84 to seal. Accordingly, even when the wafer W is lowered to the plating position (V), the contact portion 122 can be prevented from coming into contact with the plating solution.

(Fifth Embodiment)

In the following, a fifth embodiment of the present invention will be explained.

In the present embodiment, on a lower surface side of a seal member, a nail like nail portion and convex projection are formed, and an outer periphery portion of the seal member is formed to be higher than the other portion.

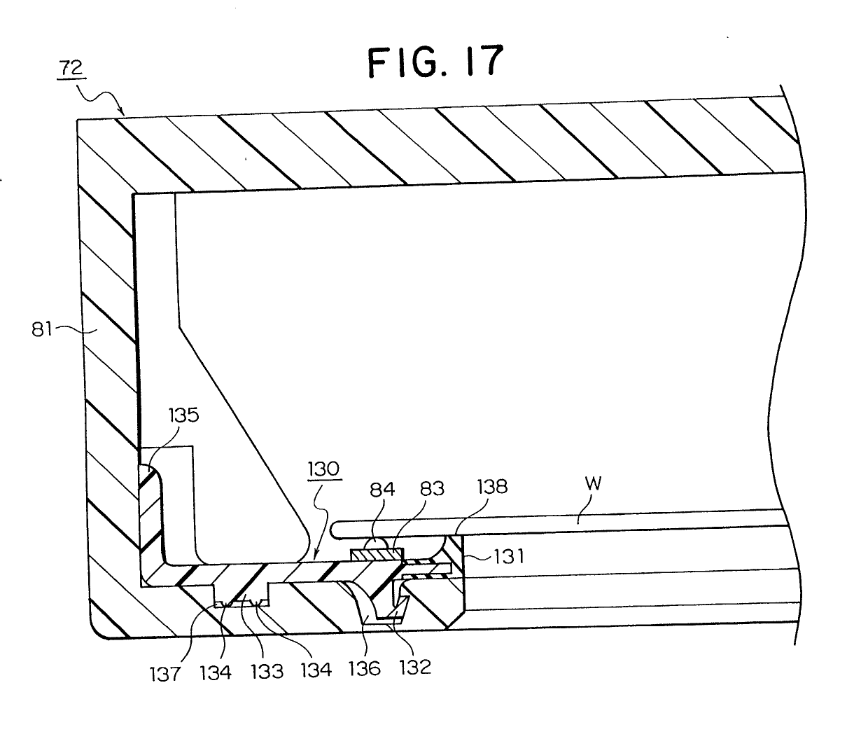

FIG. 17 is an enlarged vertical section showing schematically the holder 72 involving the present embodiment.

As shown in FIG. 17, in a seal member 130 involving the present embodiment, on a lower surface side in the neighborhood of the inner periphery surface 131, an annular and nail like nail portion 132 is formed.

Furthermore, in the seal member 130, on the lower surface side, an annular and convex portion 133 is formed, at two positions on a tip end surface of the convex portion 133 annular projections 134 being formed.

Still furthermore, an outer periphery portion 135 of the seal member 130 is formed higher than the other portion.

A contact surface 138 of the seal member 130 involving the present embodiment is formed in an approximate plane, the inner periphery surface 131 being formed in an approximate plane and approximately vertical to the contact surface 138.

Inside of a bottom surface of the holder vessel 81, an annular groove 136 having a shape corresponding to the nail portion 132 is formed, an annular concave portion 137 corresponding to the convex portion 133 being formed.

In engaging the seal member 130 to the holder 72, inside of the bottom surface of the holder vessel 81 the seal member 130 is disposed, followed by press fitting the nail portion 132 of the seal member 130 into the groove 136. Furthermore, the projection 134 of the convex portion 133 is press fitted into the concave portion 137 to elastically deform.

Thus, in the present embodiment, in addition to obtaining the effect similar with the first embodiment, since the seal member 130 has the nail-like nail portion 132 on the lower surface side of the seal member 130, in separating the wafer W from the seal member 130, it 130 can be prevented from being turned up.

That is, by plating the wafer W, in the neighborhood of the contact surface 138 of the seal member 130, the plating solution is adsorbed. Due to the plating solution adsorbed in the neighborhood of the contact surface 138, in separating the wafer W from the seal member 130, the seal member 130 is sometimes turned up.

However, in the present embodiment, the nail portion 132, being inserted into the groove 136, is engaged in the groove 136, resulting in preventing the seal member 130 from being turned up together with the wafer W.

Furthermore, the seal member 130, in addition to having the convex projection 133 on the lower surface side thereof 130, has the outer periphery portion 135 formed higher than the other portion. Accordingly, the contact 84 can be assuredly prevented from coming into contact with the plating solution.

That is, the plating solution can intrude between the seal member 130 and the holder 72 with ease. The plating solution, intruding into the outer periphery portion 135 of the seal member 130 and further overriding it 135, comes into contact with the contact 84 to corrode the contact 84.

However, in the present embodiment, the convex portion 133 is inserted into the concave portion 137. Accordingly, between the convex portion 133 and the concave portion 137, the plating solution can be prevented from intruding, resulting in preventing assuredly the contact 84 from coming into contact with the plating solution.

Furthermore, since, due to the press fitting, the projection 134 of the convex portion 133 is deformed, the intimacy between the convex portion 133 and the concave portion 137 becomes higher, resulting in preventing further assuredly the contact 84 from coming into contact with the plating solution.

Furthermore, in the present embodiment, the seal member 130 has the outer periphery portion 135 formed higher than the other portion. Accordingly, if the plating solution leaks from between the convex portion 133 and the concave portion 137, the outer periphery portion 135 would prevent the plating solution from intruding.

(Sixth Embodiment)

In the following a sixth embodiment of the present invention will be explained.

In the present embodiment, the holder 72 is equipped with a suction member sucking either one of the gas and bubbles.

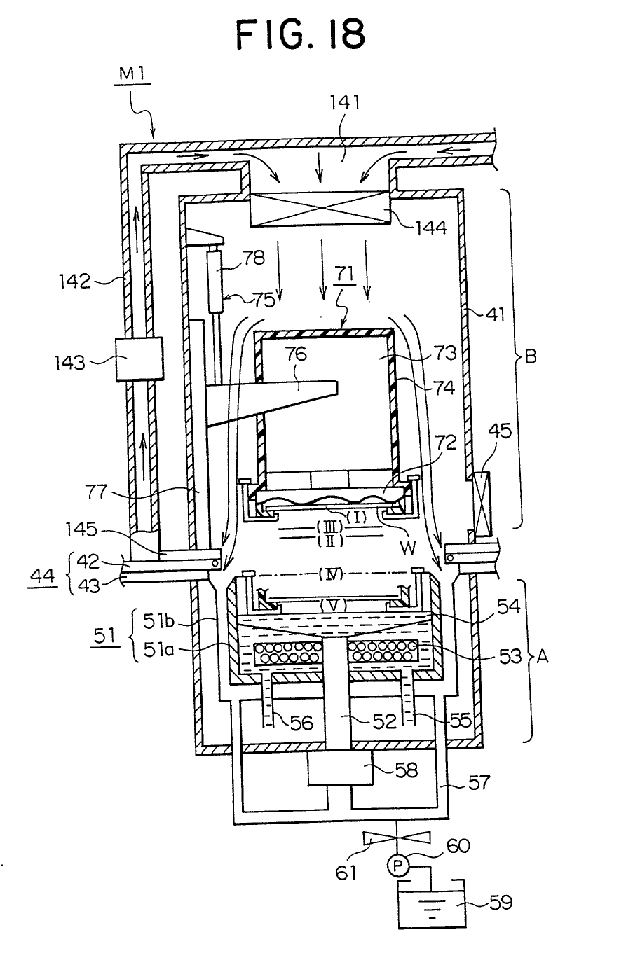

FIG. 18 is a vertical section showing schematically a plating unit M1 involving the present embodiment.

As shown in FIG. 18, at the uppermost of the housing 41, there is disposed a nitrogen nozzle 141 for sending N₂ downwardly to the first treatment portion A. To the N₂ nozzle 141, piping 142 therein the N₂ goes through is connected. To the piping 142, a N₂ supply source not shown in the figure is connected to supply the N₂.

Furthermore, in the middle of the piping 142, there is disposed a fan or compressor 143 to flow the N₂, therewith the N₂ taken in at a N₂ intake 145 being sent through the piping 142 to the N₂ nozzle 141.

A not shown controller connected to the above compressor 143 controls a flow rate of the N₂ blown out of the N₂ nozzle 141.

Still furthermore, to the N₂ nozzle 141, there is disposed a filter 144 to remove dust or dirt in the N₂, thereby cleaning the N₂. The cleansed N₂ is sent toward the N₂ intake 145 described next. Thereby, a clean atmosphere is maintained inside the second treatment portion B.

On the upper side of the separator 44, the N₂ intake 145 is formed to take in the N₂, thereby the N₂ flowed down the first treatment portion A being taken in. The N₂ intake 145 and the piping 142 are connected to enable to circulate the clean N₂.

In the neighborhood of the separator 44, an air curtain may be formed in a level direction. For instance, the separator 44 is equipped with a N₂ supply blowing the N₂ in plane and a N₂ intake on the opposite side thereof. The N₂ is blown out of the N₂ supply and, at the same time, sucked by the N₂ intake, thereby an air curtain can be formed. By forming the air curtain like this, the mist containing the plating solution from the plating solution bath 51 can be prevented from diffusing into the second treatment portion B side.

Furthermore, a temperature controller or humidity controller may be disposed inside of the plating unit M1. In that case, the inside of the plating unit M1 can be maintained at a prescribed temperature or humidity. As a result, the mist of the plating solution or the like can be prevented from occurring. Accordingly, the N₂ can be prevented from being contaminated.

Next, the holder 72 involving the present embodiment will be explained.

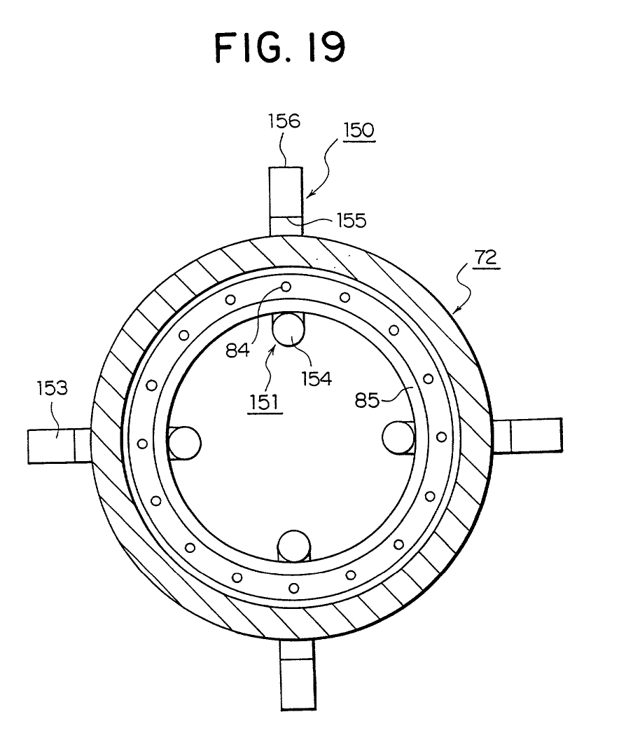

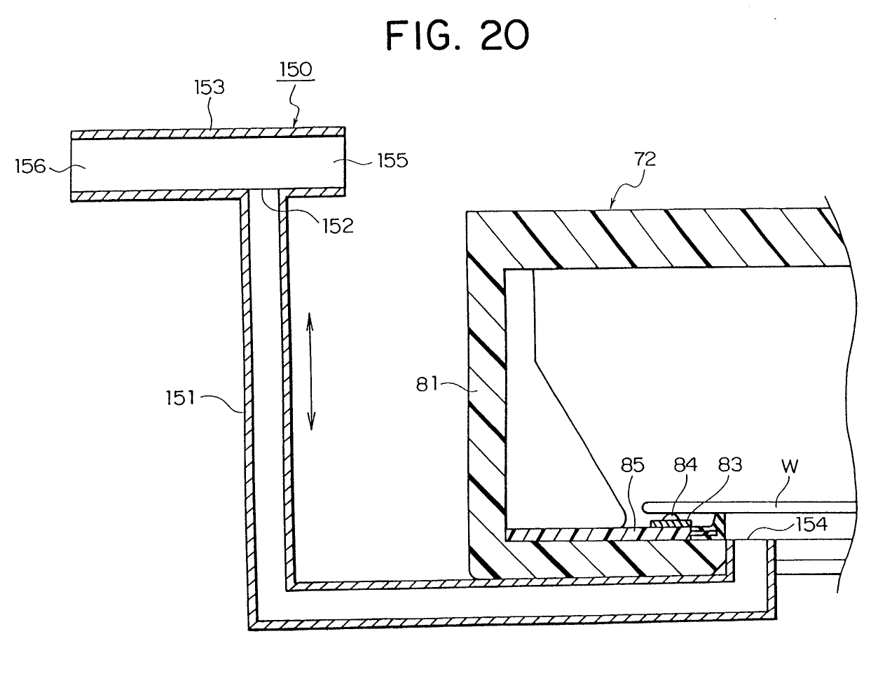

FIG. 19 is a horizontal section showing schematically the holder 72 equipped with a venturi tube involving the present embodiment, FIG. 20 being a vertical section showing schematically the holder 72 equipped with the venturi tube involving the present embodiment.

As shown in FIGS. 19 and 20, at four equally divided positions of the holder 72, over from the inside of the holder 72 to the outside thereof, a venturi tube 150 as a suction member is disposed. The venturi tube 150 is constituted of corrosion resistant material such as resin or the like.

The venturi tube 150 is constituted of a suction tube 151 and a ejection pipe 153. The suction tube 151 is disposed over from the inside of the holder 72 to the outside thereof. The ejection pipe 153 is connected to an opening 152 (hereafter, refers to as “outside opening”) present outside of the holder 72 of the suction tube 151.

Furthermore, an opening 154 (hereafter, refers to as “inside opening”) present inside of the holder 72 of the suction tube 151 is placed at a position below the surface being plated of the wafer W, specifically, at a position easy to remove for instance a gas between the wafer W and the liquid level of the plating solution, bubbles adsorbed on the surface being plated of the wafer W, or impurities such as particles. It is preferably positioned in the neighborhood of the inner periphery surface 93 of the seal member 85. The reason why it is preferable to place the inside opening 154 of the suction tube 151 in the neighborhood of the inner periphery surface 93 of the seal member 85 is as follows. That is, due to a stream of the plating solution supplied from the ejection nozzle 52, the bubbles or impurities move toward a direction outside a radius of the wafer W. Accordingly, the bubbles or the impurities tend to accumulate in particular between the inner periphery surface 93 of the seal member 85 and the wafer W.

In the ejection pipe 153, N₂ blown out of the N₂ nozzle 141 comes in directing from an opening 155 on the holder 72 side toward an opening 156 on the outfall 43 side. The N₂ comes in the ejection pipe 153 and goes through the inside of the ejection pipe 153, thereby generating a pressure difference between the neighborhoods of the outside opening 152 and inside opening 154 of the suction tube 151. That is, the pressure in the neighborhood of the outside opening 152 of the suction tube 151 becomes higher than that of the inside opening 154. Accordingly, from the neighborhood of the outside opening 152 of the suction tube 151, the gas, bubbles, or impurities existing in the neighborhood of the inside opening 154 can be sucked. Furthermore, the bubbles and impurities inhaled in the ejection pipe 153 due to the suction, along the stream of the N₂ in the ejection pipe 153, together with the plating solution, are ejected out of the opening 156 on the outfall 43 side.

Furthermore, the venturi tube 150 is structured to be freely extensible up and down, the height thereof 150 being controlled by a not shown controller. By controlling the height of the venturi tube 150 by means of the controller, irrespective of going up and down of the driver 71, the height of the ejection pipe 153 can be always controlled to that of the outfall 43. Accordingly, the mist like plating solution containing the bubbles and the impurities ejected from the ejection pipe 153 can be assuredly exhausted through the outfall 43 outside the plating system 1.

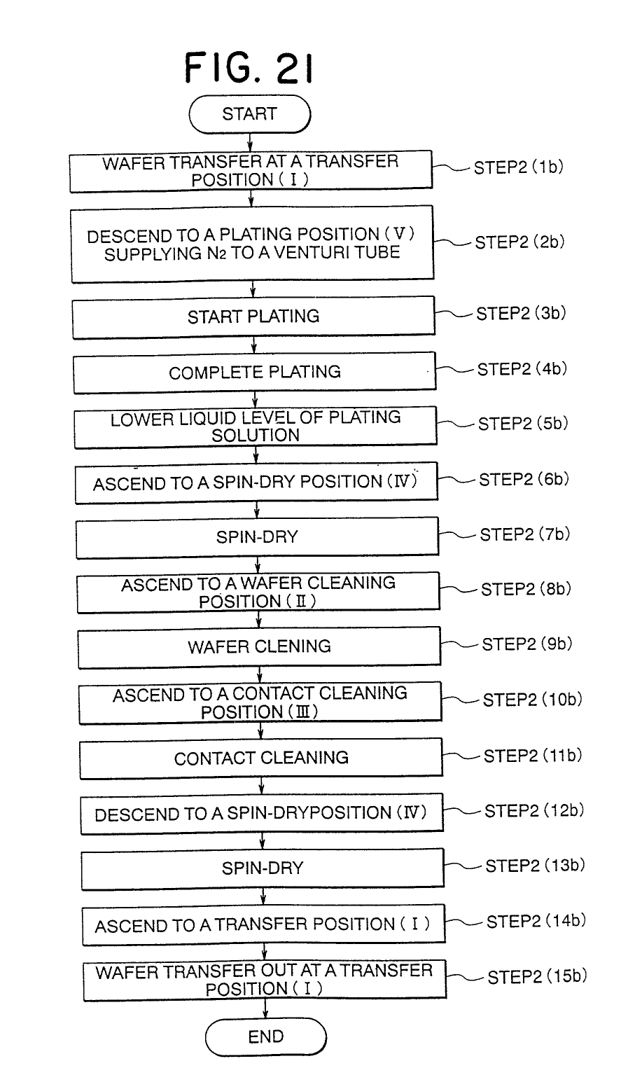

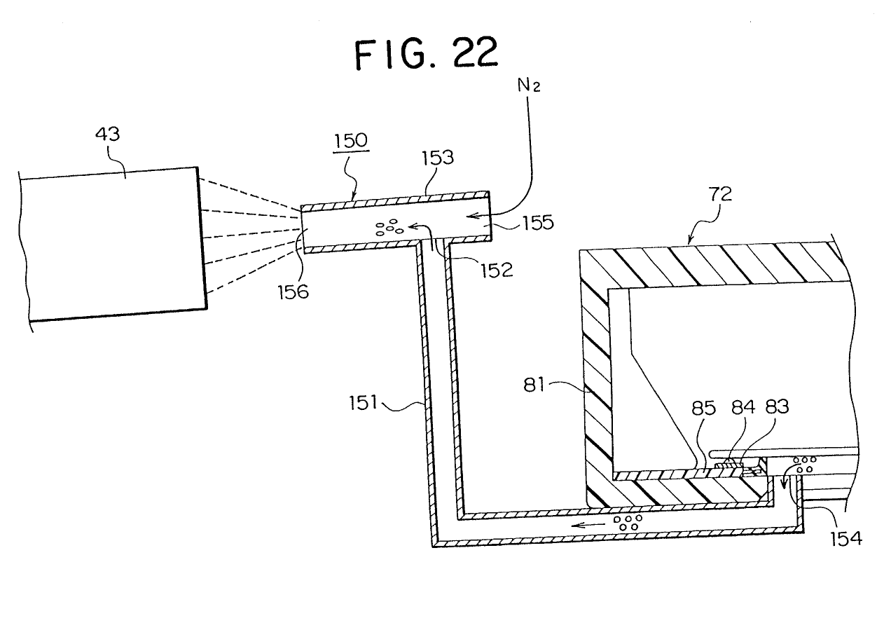

In the following, a flow of the plating process of the plating unit M1 will be explained following FIGS. 21 and 22.

FIG. 21 is a flow chart showing a flow of the plating process implemented in the plating unit M1 involving the present embodiment, FIG. 22 being a schematic state diagram when the holder 72 equipped with the venturi tube 150 involving the present embodiment is immersed in the plating solution.

First, the gate valve 45 disposed in the sidewall of the plating unit M1 is opened to transfer an untreated wafer W in the plating unit M1. Then, the wafer W is held by the holder 72 waiting at the transfer position (I) (step 2 (1b)).

After the wafer W is held in the holder 72, together with blowing out N₂ from the N₂ nozzle 141, the driver 71 is driven by the cylinder 78 to descend to place the wafer W at the plating position (V) (step 2 (2b)).

When placing the wafer W at the plating position (V), the surface being plated of the wafer W comes into contact with the liquid level of the plating solution. As mentioned above, due to the contact between the wafer W and the liquid level of the plating solution, the bubbles tend to be generated.

However, in the present embodiment, in addition to the venturi tube 150 being provided with, the N₂ is blown out of the N₂ nozzle 141. Accordingly, when these coming into contact, the bubbles are generated with difficulty.

That is, the N₂ blown out of the N₂ nozzle 141 enters in the ejection pipe 153 of the venturi tube 150 and passes therethrough 153. Thereby, between the neighborhoods of the outside opening 152 of the suction tube 151 connected to the ejection pipe 153 and the inside opening 154 thereof, a pressure difference is generated. Due to the pressure difference, the gas present between the surface being plated of the wafer W and the liquid level of the plating solution can be sucked. As a result, the surface being plated of the wafer W and the liquid level of the plating solution, with the gas present therebetween reduced, are brought into contact. Accordingly, when bought into contact, the bubbles are generated with difficulty, resulting in the reduction of the bubbles adsorbed on the surface being plated of the wafer W.

Furthermore, even during placing the wafer W from the liquid level of the plating solution to the plating position (V), the N₂ is blown out of the N₂ nozzle 141. Accordingly, even when, during the contact, the bubbles are generated and adsorbed on the surface being plated of the wafer W, as shown in FIG. 22, the bubbles can be assuredly sucked from the surface being plated of the wafer W to remove. In that case, the bubbles sucked in the ejection pipe 153, along the stream of the N₂ in the ejection pipe 153, are ejected in mist together with the plating solution, from the opening 156 on the outfall 43 side of the ejection pipe 153. Furthermore, due to the suction, the impurities in the neighborhood of the inside opening 154 of the suction tube 151 can be also sucked to remove from the surface being plated of the wafer W.

As to the height of the venturi tube 150, by extending the venturi tube 150 by means of a not shown controller, the height of the ejection pipe 153 of the venturi tube 150 is always controlled to the height of the outfall 43. Accordingly, even when the driver 71 is lowered, the plating solution ejected from the ejection pipe 153 can be assuredly exhausted through the outfall 43 outside the plating system 1.

Furthermore, the flow rate of the N₂ blowing out of the N₂ nozzle 141 is controlled to one that can assuredly remove the gas, bubbles, or impurities.

After placing at the plating position (V), a voltage is applied between the anode 53 and cathode 83 to implement the plating on the surface being plated of the wafer W (step 2 (3b)).

In the present embodiment, since the bubbles have been assuredly removed from the surface being plated of the wafer W, the plating solution can be brought into uniform contact with the surface being plated of the wafer W, resulting in uniform plating thereon.

The suction of the bubbles and impurities due to the venturi tube 150 continues automatically as far as the N₂ nozzle 141 is blowing out the N₂. Accordingly, the bubbles and impurities generated during the plating on the surface being plated of the wafer W can be also sucked by the venturi tube 150 to remove.

After plating on the surface being plated of the wafer W with a sufficient thickness, the voltage is ceased to apply to finish the plating (step 2 (4b)).

Subsequently, by the operation of the pump 60 and the release of the valve 61, the liquid level of the plating solution is lowered (step 2 (5b)).

Thereafter, the wafer W is placed at the spin-dry position (VI) to spin dry (step 2 (6b), (7b)).

After sufficiently spin drying, the wafer W is moved to the wafer cleaning position (II) to cleanse the surface being plated of the wafer W (step 2 (8b), (9b)).

After the completion of the cleaning of the surface being plated of the wafer W, the wafer W is moved to the contact cleaning position (III) to cleanse the contact 84 (step 2 (10b), (11b)).

After the completion of the cleaning of the contact 84, the wafer W is placed at the spin dry position (IV) to spin dry (step 2 (12b), (13b)).

After sufficiently spin drying, the wafer W is moved to the transfer position (I) to send the wafer W out of the plating unit M1 (step 2 (14b), (15b)).

(Seventh Embodiment)

In the following, a seventh embodiment of the present invention will be explained.

In the present embodiment, a double venturi tube is used for the venturi tube to configure.

That is, the ejection pipe is configured in a dual pipe to expedite the flow rate of the N₂ in the ejection pipe.

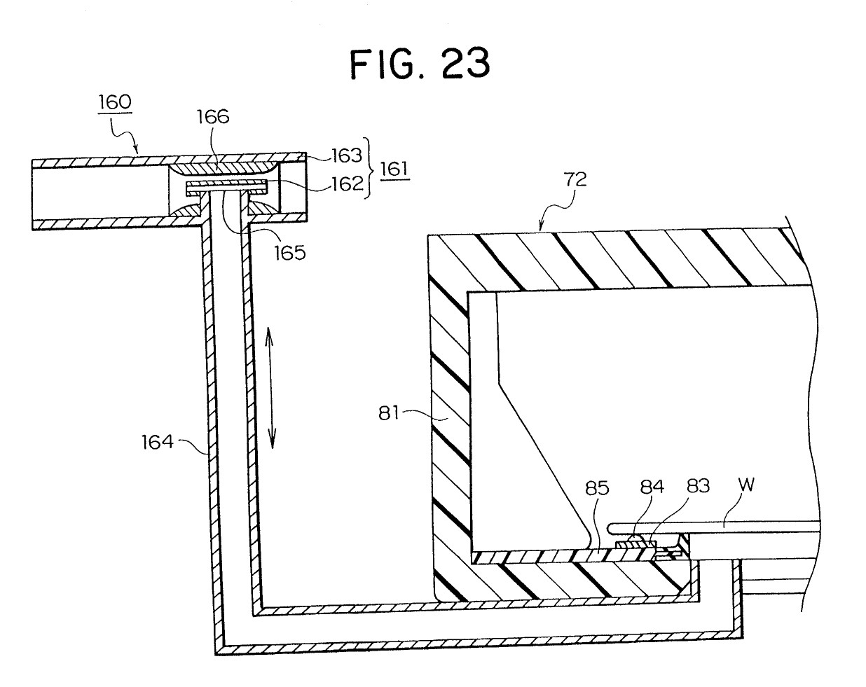

FIG. 23 is a vertical section showing schematically the holder 72 equipped with a double venturi tube involving the present embodiment.

As shown in FIG. 23, an ejection pipe 161 of a double venturi tube 160 involving the present embodiment is constituted of a dual pipe. Specifically, it is constituted of for instance an inner ejection pipe 162 disposed inside and an outer ejection pipe 163 disposed concentrically outside the inner ejection pipe 162.

The inner ejection pipe 162 is shorter than the outer ejection pipe 163, to the inner ejection pipe 162 an outside opening 165 of a suction tube 164 being connected. Inside the inner ejection pipe 162, N₂ blown out of the N₂ nozzle 141 enters and goes through the inside of the inner ejection pipe 162. Thereby, the N₂ is enhanced in its flow rate to enable to suck more strongly.

Furthermore, on an inner wall of the outer ejection pipe 163, an annular projection 166 is formed so that surrounds the inner ejection pipe 162. By the formation of the annular projection 166, the flow rate of N₂ passing through the neighborhood of the inner wall of the outer ejection pipe 163 can be heightened.

The flow rate of the N₂ passing through the inner ejection pipe 162 is higher than that of the N₂ passing through the neighborhood of the inner wall of the outer ejection pipe 163. Accordingly, the N₂ passed through the inner ejection pipe 162, even after coming out in the neighborhood of the center of the outer ejection pipe 163, does not mingle with the N₂ in the neighborhood of the inner wall. That is, the N₂ passed through the inner ejection pipe 162 keeps flowing in the neighborhood of the center of the outer ejection pipe 163.

Next, a state when the holder 72 equipped with the double venturi tube 160 involving the present embodiment is immersed in the plating solution will be explained.

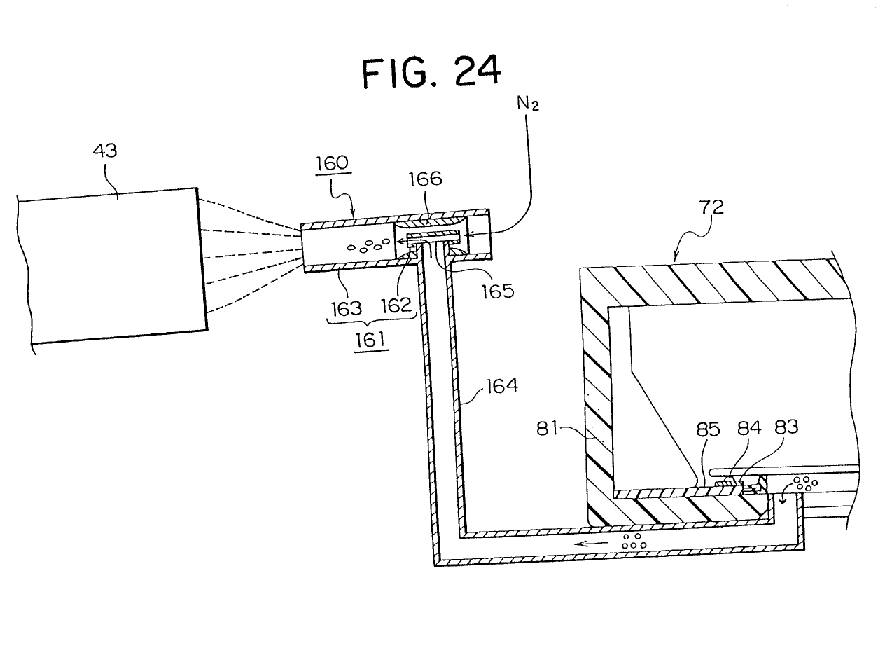

FIG. 24 is a schematic state diagram when the holder 72 equipped with the double venturi tube 160 involving the present embodiment is immersed in the plating solution.

As shown in FIG. 24, N₂ blown out of the N₂ nozzle 141 enters into the inner and outer ejection pipes 162 and 163 of the double venturi tube 160, respectively. The N₂ entering in the neighborhood of the inner wall of the outer ejection pipe 163 is enhanced in its flow rate by the projection 166. The N₂ entering in the inner ejection pipe 162 is enhanced in its flow rate in the inner ejection pipe 162. Due to the N₂ of which flow rate is heightened by the inner ejection pipe 162, the suction in the neighborhood of the outside opening 165 of the suction tube 164 is increased. Thereby, the bubbles and impurities adsorbed on the surface being plated of the wafer W are sucked together with the plating solution. The bubbles and impurities sucked in the inner ejection pipe 162 due to the suction come out, together with the plating solution, from the inner ejection pipe 162 into the neighborhood of the center of the outer ejection pipe 163 along a stream of the N₂. Thereafter, these are ejected in mist from the neighborhood of the center of the outer ejection pipe 163 toward the outfall 43 and are exhausted through the outfall 43 outside the plating system 1. The N₂ coming out in the neighborhood of the center of the outer ejection pipe 163 after passing through the inner ejection pipe 162 does not mingle with the N₂ in the neighborhood of the inner wall of the outer ejection pipe 163. That is, the above N₂ keeps flowing in the neighborhood of the center of the outer ejection pipe 163. As a result, the plating solution coming out together with the N₂ in the neighborhood of the center of the outer ejection pipe 163 can be reduced in adsorption on the inner wall of the outer ejection pipe 163. Accordingly, the plating solution can be prevented from precipitating on the inner wall of the outer ejection pipe 163 to form particles.

Thus, in the present embodiment, due to the double venturi tube 160 configuration of the venturi tube, the suction is enhanced to result in more effective suction of the gas, bubbles or the impurities.

The present invention is not restricted to the contents of the aforementioned first through seventh embodiments, and the structure, materials, arrangement of the respective members or the like can be appropriately modified in the range without departing from the scope of the present invention.

For instance, in the first through seventh embodiments, only one surface of the wafer W is plated. However, with a plurality of different treatment solution baths, while reversing, different liquid treatment can be applied on both surfaces of the wafer W.

Furthermore, in the first through seventh embodiments, the annealing unit AN is disposed for the explanation purpose. However, a treatment unit other than the annealing unit AN, for instance a pre-treatment unit for implementing surface treatment prior to the plating or a post-treatment unit for treating the wafer W after the plating may be disposed.

Furthermore, in the first through seventh embodiments, the wafer W is used as the substrate. However, a LCD glass substrate for liquid crystal display may be used.

Still furthermore, in the first through seventh embodiments, the plating as the liquid treatment is explained. However, any liquid treatment with liquid can be used.

Furthermore, in the third embodiment, at two positions the leading paths 115 are formed. However, at one or three or more positions, the leading paths 115 may be formed.

Still furthermore, in the fifth embodiment, the seal member 130 comprises the nail portion 132, convex portion 133 and outer periphery portion 135. However, the seal member 130 need only comprise either one of the nail portion 132, convex portion 133 and outer periphery portion 135.

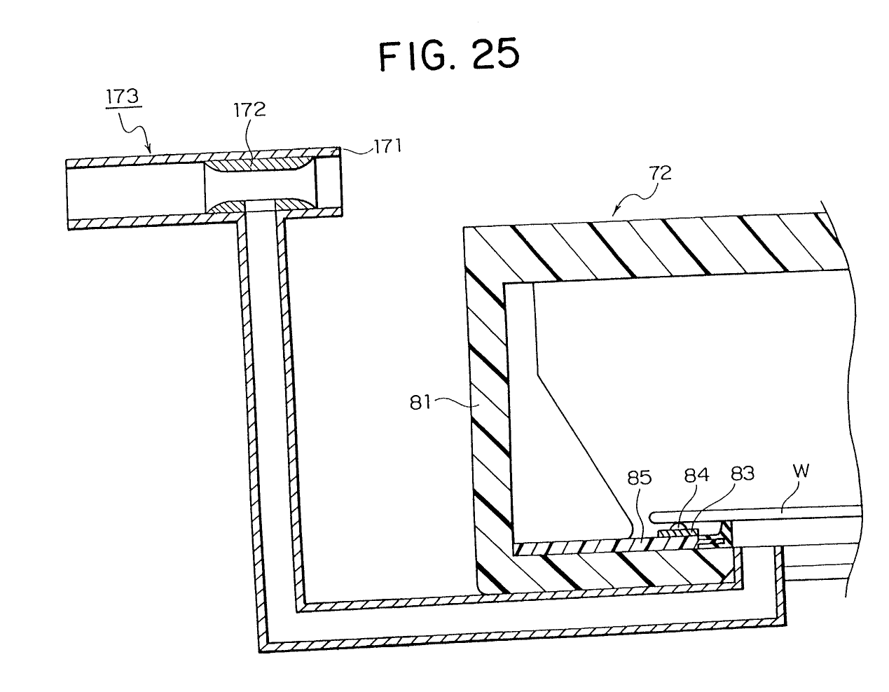

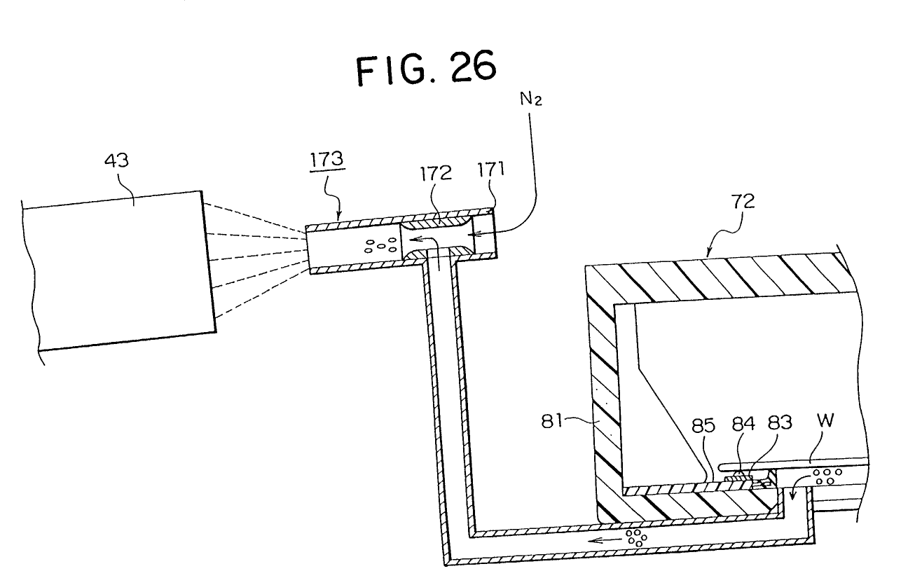

Furthermore, FIG. 25 is a schematic vertical section of the holder 72 equipped with a single venturi tube, FIG. 26 being a schematic state diagram when the holder 72 equipped with the single venturi tube is immersed in the plating solution. In the sixth and seventh embodiments, the venturi tube 150 with no projection or the double venturi tube 160 of dual pipe provided with the projection 166 is used. However, as shown in FIGS. 25 and 26, for the ejection pipe 171, the single venturi tube 173 to which only projection 172 is formed may be used.

Still furthermore, in the sixth and seventh embodiments, as the suction member the venturi tube 150 and the double venturi tube 160 are employed. However, any one that can suck either one of the gas and the bubbles can be applied. Specifically, an aspirator or a vacuum can be used.

Furthermore, in the sixth and seventh embodiments, before and after the surface being plated of the wafer W is brought into contact with the liquid level of the plating solution, the venturi tube 150 or the double venturi tube 160 is used to suck. However, it may be either one of before and after bringing into contact.

Still furthermore, in the sixth and seventh embodiments, N₂ is supplied to either one of the venturi tube 150 and the double venturi tube 160, however air can be supplied instead of N₂.

Furthermore, in the sixth and seventh embodiments, the seal member 85 of the first embodiment is employed, however the seal member is not restricted thereto. That is, the seal members 100 and 110 as used in the second and third embodiments, or generally used seal member may be used.

Still furthermore, in the sixth and seventh embodiments, the bubbles are sucked while immersing the wafer W in the plating solution. However, after immersing the wafer W, the bubbles can be sucked.

What is claimed is:

1. Liquid treatment equipment, comprising:
a treatment solution bath accommodating a treatment solution;
a holder holding a substrate and bringing a surface being treated of the substrate into contact with the treatment solution; and
an annular seal member sealing between the surface being treated of the substrate and the holder;
wherein, in a sealed state, at a boundary portion between an inner periphery surface of the seal member and a contact surface in contact with the surface being treated of the substrate, a brim portion of a radius of curvature of 0.5 mm or less exists.

2. The liquid treatment equipment as set forth in claim 1:
wherein the contact surface is formed in an approximate plane, and the inner periphery surface is formed in an approximate plane and approximately vertical with respect to the contact surface.

3. The liquid treatment equipment as set forth in claim 1:
wherein the contact surface is formed in a radius of curvature of 0.1 mm or more.

4. The liquid treatment equipment as set forth in claim 1, further comprising:
a suction member disposed in the holder and sucking either one of a gas and bubbles present in the neighborhood of the surface being treated of the substrate.

5. Liquid treatment equipment, comprising:
a treatment solution bath accommodating a treatment solution;
a holder holding a substrate and bringing a surface being treated of the substrate into contact with the treatment solution;
a first electrode disposed in the-holder and coming into contact with the surface being treated of the substrate;
a second electrode disposed in the treatment solution bath and applied thereto a voltage between the first electrode; and
an annular seal member comprising an inside seal portion disposed more inside than a contact portion to seal the contact portion between the first electrode and the surface being treated of the substrate and an outside seal portion disposed more outside than the contact portion;
wherein, in a sealed state, at a boundary portion between an inner periphery surface of the inside seal portion and a contact surface in contact with the surface being treated of the substrate, a brim portion of a radius of curvature of 0.5 mm or less exists.

6. The liquid treatment equipment as set forth in claim 5:
wherein the contact surface is formed in an approximate plane, and the inner periphery surface is formed in an approximate plane and approximately vertical with respect to the contact surface.

7. The liquid treatment equipment as set forth in claim 5:
wherein the contact surface is formed in a radius of curvature of 0.1 mm or more.

8. The liquid treatment equipment as set forth in claim 5:
wherein the seal member is provided with a leading path formed over from the inside seal portion to the outside seal portion.

9. The liquid treatment equipment as set forth in claim 5:
wherein the holder is provided with a rear surface cover covering a rear surface of the substrate.

10. The liquid treatment equipment as set forth in claim 5, further comprising:
a suction member disposed to the holder and sucking either one of a gas and bubbles present in the neighborhood of the surface being treated of the substrate.

11. Liquid treatment equipment, comprising:
a treatment solution bath accommodating a treatment solution;
a holder holding a substrate and bringing a surface being treated of the substrate into contact with the treatment solution;
a first electrode disposed in the holder and coming into contact with the surface being treated of the substrate;
a second electrode disposed in the treatment solution bath and applied thereto a voltage between the first electrode; and
a suction member disposed to the holder and sucking either one of a gas and bubbles in the neighborhood of the surface being treated of the substrate.

12. The liquid treatment equipment as set forth in claim 11:
wherein the suction member comprises a venturi tube and a gas supplier for supplying a gas to the venturi tube.

13. The liquid treatment equipment as set forth in claim 12:
wherein the venturi tube is a double venturi tube.

14. A liquid treatment method, comprising:
a step of immersing where a surface being treated of a substrate, directed downward, while sucking a gas in the neighborhood of the surface being treated of the substrate, is brought into contact with a liquid level of a plating solution to immerse in the treatment solution; and
a step of liquid treating where, after immersing the surface being treated of the substrate in the treatment solution, an electric current is sent to the substrate to implement liquid treatment to the surface being treated of the substrate.

15. The liquid treatment method as set forth in claim 14:
wherein the step of immersing is one where the surface being treated of the substrate, after being brought into contact with the liquid level of the treatment solution, while sucking bubbles in the neighborhood of the surface being treated of the substrate, is immersed.

16. A liquid treatment method, comprising:
a step of immersing where a surface being treated of a substrate, directed downward, after being brought into contact with a liquid level of a treatment solution, while sucking a gas in the neighborhood of the surface of the substrate, is immersed in the treatment solution; and
a step of liquid treating where, after immersing the surface being treated of the substrate in the treatment solution, an electric current is sent to the substrate to implement the liquid treatment on the surface being treated of the substrate.

17. A liquid treatment method, comprising:
a step of sucking where with a surface being treated of a substrate directed downward and immersed in a treatment solution, bubbles in the neighborhood of the surface being treated of the substrate are sucked; and
a step of liquid treating where, after sucking the bubbles, an electric current is sent to the substrate to implement liquid treatment on the surface being treated of the substrate.
